(19) United States
(12) Patent Application Publication
(10) Pub. No.: US 2012/0289364 A1
(43) Pub. Date: Nov. 15, 2012

(54) REINFORCING IONOMERIC MATERIALS USING MULTI-FUNCTIONAL MODIFIER WITH ACID FUNCTIONAL GROUP

(75) Inventors: Hyun J. Kim, Carlsbad, CA (US); Hong G. Jeon, Carlsbad, CA (US)

(73) Assignee: Taylor Made Golf Company, Inc.

(21) Appl. No.: 13/337,698

(22) Filed: Dec. 27, 2011

Related U.S. Application Data
(60) Provisional application No. 61/427,597, filed on Dec. 28, 2010.

(51) Int. Cl. A63B 37/00; A63B 37/12; C08G 18/06; A63B 37/08

(52) U.S. Cl. 473/373; 473/371; 473/372; 473/385; 528/71

(57) ABSTRACT

A golf ball comprising a core and at least one layer, wherein at least the core or the layer includes a polyurethane ionomer made by reacting a multi-functional modified ionomer with an isocyanate, wherein the multi-functional modified ionomer is a product of reacting an ionomer with a multi-functional modifier wherein the multi-functional modifier includes at least one carboxyl functional group and at least two additional types of functional groups.

### CROSS-REFERENCE TO RELATED APPLICATION

This application claims the benefit of U.S. Provisional Application No. 61/427,597, which was filed on Dec. 28, 2010, and is incorporated herein by reference in its entirety.

### BACKGROUND

The application of synthetic polymer chemistry to the field of sports equipment has revolutionized the performance of athletes in many sports. One sport in which this is particularly true is golf, especially as relates to advances in golf ball performance and ease of manufacture. For instance, the earliest golf balls consisted of a leather cover filled with wet feathers. These “feathery” golf balls were subsequently replaced with a single piece golf ball made from “gutta percha,” a naturally occurring rubber-like material. In the early 1900's, the wound rubber ball was introduced, consisting of a solid rubber core around which rubber thread was tightly wound with a gutta percha cover.

More modern golf balls can be classified as one-piece, two-piece, three-piece or multi-layered golf balls. One-piece balls are molded from a homogeneous mass of material with a dimple pattern molded thereon. One-piece balls are inexpensive and very durable, but do not provide great distance because of relatively high spin and low velocity. Two-piece balls are made by molding a cover around a solid rubber core. These are the most popular types of balls in use today. In attempts to further modify the ball performance especially in terms of the distance such balls travel and the feel transmitted to the golfer through the club on striking the ball, the basic two piece ball construction has been further modified by the introduction of additional layers between the core and outer cover layer. If one additional layer is introduced between the core and outer cover layer a so called “three-piece ball” results and similarly, if two additional layers are introduced between the core and outer cover layer, a so called “four-piece ball” results, and so on.

Golf ball covers were previously made from balata rubber which was favored by some players because the softness of the cover allows them to achieve spin rates sufficient to allow more precisely control of ball direction and distance, particularly on shorter approach shots. However balata-covered balls, although exhibiting high spin and soft feel, were often deficient in terms of the velocity of the ball when it leaves the club face which in turn affects the distance the ball travels.

Accordingly, a variety of golf ball constructions have been developed in an attempt to provide spin rates and a feel approaching those of balata covered balls, while also providing a golf ball with a higher durability and overall distance. This has resulted in the emergence of balls, which have a solid rubber core, a cover, and one, or more so called intermediate layers, as well as the application of new materials to each of these components.

A material which has been often utilized in more modern golf balls is the family of ionomer resins developed in the mid-1960's, by E.I. DuPont de Nemours and Co., and sold under the trademark SURLYN®. These ionomer resins have, to a large extent, replaced balata as a golf ball cover stock material. Preparation of such ionomers is well known, for example see U.S. Pat. No. 3,264,272 (the entire contents of which are herein incorporated by reference). Generally speaking, commercial ionomers consist of a polymer of a mono-olefin, e.g., an alkene, with an unsaturated mono- or dicarboxylic acids having 3 to 12 carbon atoms. An additional monomer in the form of a mono- or dicarboxylic acid ester may also be incorporated in the formulation as a so-called “softening comonomer.” The acid groups in the polymer are then neutralized to varying degrees by addition of a neutralizing agent in the form of a basic metal salt.

Today, there are a wide variety of commercially available ionomer resins based both on copolymers of ethylene and (meth)acrylic acid or terpolymers of ethylene and (meth)acrylic acid and (meth)acrylate, all of which many of which are be used as a golf ball component. The properties of these ionomer resins can vary widely due to variations in acid content, softening comonomer content, the degree of neutralization, and the type of metal ion used in the neutralization.

More recent developments in the field have attempted to utilize the various types of ionomers, both singly and in blend compositions to optimize the often conflicting golf ball performance requirements of high C.O.R. and ball velocity, and cover durability, with the need for a ball to spin and have a so-called soft feel on shorter iron shots. However, the incorporation of more acid in the ionomer and/or increasing its degree of neutralization results in a material with increased polarity, and hence one which is often less compatible with other potential blend materials. Also increasing the acid content of the ionomer while increasing C.O.R. may render the ball too hard and brittle causing a loss of shot feel, control (i.e., the ability to spin the ball) and may render the cover too brittle and prone to premature failure. Finally, the incorporation of more acid in the ionomer and/or increasing its degree of neutralization typically results in an increase in melt viscosity which in turn greatly decreases the processability of these resins. Attempts to mediate these effects by adding softer terpolymeric ionomers to high acid ionomer compositions to adjust the hardness and improve the shot “feel” often result in concomitant loss of C.O.R. and hence distance.

In addition, various hard-soft ionomer blends, that is, mixtures of ionomer resins, which are significantly different in hardness and/or flexural modulus, have been evaluated for use in golf balls. For instance, U.S. Pat. No. 4,884,814 discloses the blending of various hard methacrylic based ionomer resins with similar or larger quantities of one or more “soft” ionomer methacrylic acid based ionomer resins (i.e., those ionomer resins having a hardness from about 25 to 40 as measured on the Shore D scale) to produce relatively low modulus golf ball cover compositions that are not only softer than the prior art hard ionomer covers but also exhibit a sufficient degree of durability for repetitive play. These relatively low modulus cover compositions were generally comprised of from about 25 to 70% of hard ionomer resins and from about 30 to 75% of soft ionomer resins.

Also, U.S. Pat. No. 5,324,783 discloses golf ball cover compositions comprising a blend of a relatively large amount, e.g., 70-90 wt. %, of hard ionomer resins with a relatively low amount, e.g., 10 to about 25-30 wt. %, of soft ionomers. The hard ionomers are sodium or zinc salts of a copolymer of an olefin having from 2 to 8 carbon atoms and an unsaturated monocarboxylic acid having from 3 to 8 carbon atoms. The soft ionomer is a sodium or a zinc salt of a terpolymer of an olefin having from 2 to 8 carbon atoms, methacrylic acid and an unsaturated monomer of the acrylate ester class having from 1 to 21 carbon atoms.

In order to further extend the range of properties of the ionomer resins to optimize golf ball performance, additional components have been added to them as “modifiers.” For example, U.S. Pat. No. 4,104,216 (Clampitt) discloses ionomers modified with 5-50 weight percent of a long chain (un)saturated fatty acid.

Also, Japanese Patent Application No. 48/70757 discloses ionomers modified with a high level of a low molecular weight saturated or unsaturated carboxylic acid or salt or anhydride, specifically 10 to 500 parts per 100 parts by weight of ionomer. The carboxylic acid may have 1 to 100 hydrocarbon carbon chain units. Stearic, citric, oleic and glutamic acid and/or salts are exemplified.

U.S. Pat. Nos. 5,312,857 and 5,306,760 disclose cover compositions for golf ball construction comprising mixtures of ionomer resins and 25-100 parts by weight of various fatty acid salts (i.e., metal stearates, metal oleates, metal palmitates, metal pelargonates, metal laurates, etc.).

U.S. Pat. No. 6,100,321 and U.S. Patent Publication No. 2003/0158312 A1, disclose ionomer compositions, which are modified with 25 to 100 parts by weight of a fatty acid salt such as a metal stearate, for the production of golf balls with good resilience and high softness. Unlike the earlier mentioned patents, which have employed metal stearates as a filler material, these patents disclose the use of relatively low levels of a stearic acid moiety, especially calcium stearate, to modify ionomers to produce improved resilience for a given level of hardness or PGA Compression values. The stearate-modified ionomers are taught as being especially useful when the ionomer is formulated for use as a golf ball core, center, one-piece ball, or as a soft golf ball cover.

Subsequent patent applications have furthered the use of such modified ionomers in golf ball covers. For example U.S. Pat. No. 6,329,458 is directed to a golf ball cover comprising an ionomer resin and a metal “soap,” e.g., calcium stearate. Finally, U.S. Pat. No. 6,616,552 discloses a golf ball including a multi-layer cover, one layer of which includes a heated mixture of an ionomer resin and a metal salt of a fatty acid, e.g., calcium stearate.

### SUMMARY

Disclosed herein are polyurethane ionomers that are made by reacting a multi-functional-modified ionomer with an isocyanate. The multi-functional-modified ionomer is made by mixing, preferably reacting, a multi-functional modifier agent with an ionomer. The polyurethane ionomers may be included in any structural component of a golf ball or sports equipment, such as core, intermediate layer, and/or cover layer of a golf ball.

In one embodiment, there is disclosed herein a golf ball comprising a core and at least one layer, wherein at least the core or the layer includes a polyurethane ionomer made by reacting a multi-functional modified ionomer with an isocyanate, wherein the multi-functional modified ionomer is a product of reacting an ionomer with a multi-functional modifier wherein the multi-functional modifier includes at least one carboxyl functional group and at least two additional types of functional groups.

In a further embodiment, there is disclosed herein a polyurethane ionomer comprising the reaction product of a multi-functional modified ionomer with an isocyanate, wherein the multi-functional modified ionomer is a product of reacting an ionomer with a multi-functional modifier wherein the multi-functional modifier includes at least one carboxyl functional group and at least two additional types of functional groups.

According to another embodiment, there is disclosed herein a method for making a golf ball, comprising reacting an ionomer with a multi-functional modifier to produce a multi-functional modified ionomer, wherein the multi-functional modifier includes at least one carboxyl functional group and at least two additional types of functional groups;

reacting the multi-functional modified ionomer with an isocyanate to produce a polyurethane ionomer; and

forming the polyurethane ionomer into a golf ball component.

Also disclosed herein is a method comprising reacting an ionomer with a multi-functional modifier to produce a multi-functional modified ionomer, wherein the multi-functional modifier includes at least one carboxyl functional group and at least two additional types of functional groups; and

reacting the multi-functional modified ionomer with an isocyanate to produce a polyurethane ionomer.

The foregoing and will become more apparent from the following detailed description, which proceeds with reference to the accompanying figures.

### BRIEF DESCRIPTION OF THE DRAWINGS

FIG. 1 illustrates a three-piece golf ball 1 comprising a solid center or core 2, an intermediate layer 3, and an outer cover layer 4.

FIG. 2 illustrates a 4-piece golf ball 1 comprising a core 2, and an outer cover layer 5, an inner intermediate layer 3, and an outer intermediate layer 4.

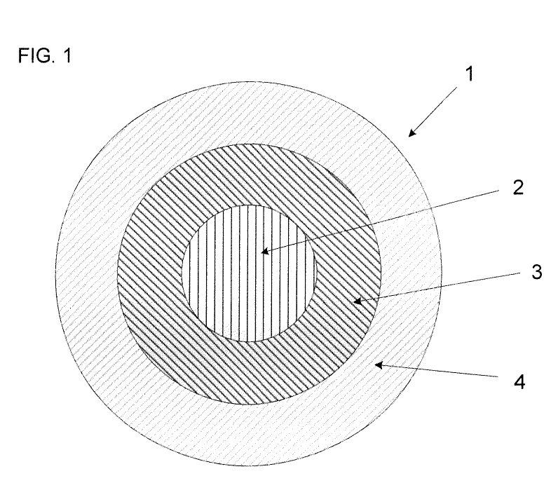

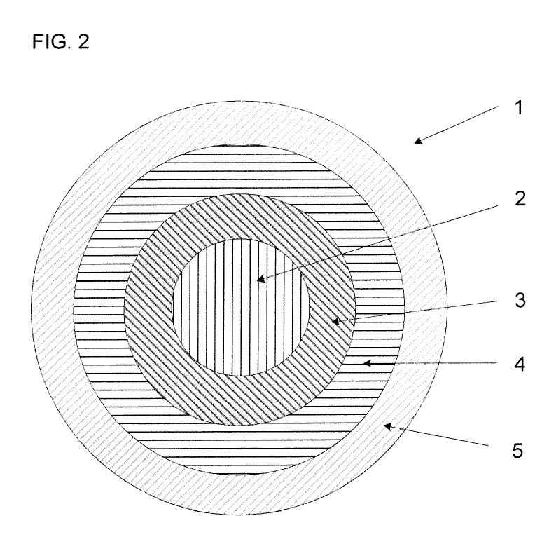

Although FIGS. 1 and 2 illustrate only three- and four-piece golf ball constructions, golf balls of the present disclosure may comprise from 1 to at least 5 intermediate layer(s), preferably from 1 to 3 intermediate layer(s).

### DETAILED DESCRIPTION

The term descriptions below are provided solely to aid the reader, and should not be construed to have a scope less than that understood by a person of ordinary skill in the art or as limiting the scope of the appended claims.

The term “(meth)acrylic acid copolymers” is intended to mean copolymers of methacrylic acid and/or acrylic acid.

The term “(meth)acrylate” is intended to mean an ester of methacrylic acid and/or acrylic acid.

The term “partially neutralized” is intended to mean an ionomer with a degree of neutralization of less than 100 percent.

The term “hydrocarbyl” is intended to mean any aliphatic, cycloaliphatic, aromatic, aryl substituted aliphatic, aryl substituted cycloaliphatic, aliphatic substituted aromatic, or cycloaliphatic substituted aromatic groups. The aliphatic or cycloaliphatic groups are preferably saturated. Likewise, the term “hydrocarbyloxy” means a hydrocarbyl group having an oxygen linkage between it and the carbon atom to which it is attached.

As used herein, the term “core” is intended to mean the elastic center of a golf ball. The core may have one or more “core layers” of elastic material, which are usually made of rubbery material such as diene rubbers.

The term “cover layer” is intended to mean the outermost layer of the golf ball; this is the layer that is directly in contact with paint and/or ink on the surface of the golf ball. If the cover consists of two or more layers, only the outer most layer is designated the cover layer, and the remaining layers (excluding the outermost layer) are commonly designated intermediate layers as herein defined. The term “outer cover layer” as used herein is used interchangeably with the term “cover layer.”

The term “intermediate layer” may be used interchangeably herein with the terms “mantle layer” or “inner cover layer” and is intended to mean any layer(s) in a golf ball disposed between the core and the outer cover layer. Should a ball have more than one intermediate layer, these may be distinguished as “inner intermediate” or “inner mantle” layers which are used interchangeably to refer to the intermediate layer nearer the core and further from the outer cover, as opposed to the “outer intermediate” or “outer mantle layer” which are also used interchangeably to refer to the intermediate layer further from the core and closer to the outer cover.

The term “prepolymer” as used herein is intended to mean any material that can be further processed to form a final polymer material of a manufactured golf ball, such as, by way of example and not limitation, a polymerized or partially polymerized material that can undergo additional processing, such as crosslinking.

A “thermoplastic” as used herein is intended to mean a material that is capable of softening or melting when heated and of hardening again when cooled. Thermoplastic polymer chains often are not cross-linked or are lightly crosslinked using a chain extender, but the term “thermoplastic” as used herein may refer to materials that initially act as thermoplastics, such as during an initial extrusion process or injection molding process, but which also may be crosslinked, such as during a compression molding step to form a final structure.

A “thermoset” as used herein is intended to mean a material that crosslinks or cures via interaction with as crosslinking or curing agent. Crosslinking may be induced by energy, such as heat (generally above 200° C.), through a chemical reaction (by reaction with a curing agent), or by irradiation. The resulting composition remains rigid when set, and does not soften with heating. Thermosets have this property because the long-chain polymer molecules cross-link with each other to give a rigid structure. A thermoset material cannot be melted and re-molded after it is cured. Thus thermosets do not lend themselves to recycling unlike thermoplastics, which can be melted and re-molded.

The term “thermoplastic polyurethane” as used herein is intended to mean a material prepared by reaction of a prepared by reaction of a diisocyanate with a polyol, and optionally addition of a chain extender.

The term “thermoplastic polyurea” as used herein is intended to mean a material prepared by reaction of a prepared by reaction of a diisocyanate with a polyamine, with optionally addition of a chain extender.

The term “thermoset polyurethane” as used herein is intended to mean a material prepared by reaction of a diisocyanate with a polyol, and a curing agent.

The term “thermoset polyurea” as used herein is intended to mean a material prepared by reaction of a diisocyanate with a polyamine, and a curing agent.

A “urethane prepolymer” as used herein is intended to mean the reaction product of diisocyanate and a polyol.

A “urea prepolymer” as used herein is intended to mean the reaction product of a diisocyanate and a polyamine.

The term “zwitterion” as used herein is intended to mean a form of a compound having both an amine group and carboxylic acid group, where both groups are charged and where the net charge on the compound is neutral.

The term “bimodal polymer” refers to a polymer comprising two main fractions and more specifically to the form of the polymers molecular weight distribution curve, i.e., the appearance of the graph of the polymer weight fraction as function of its molecular weight. When the molecular weight distribution curves from these fractions are superimposed into the molecular weight distribution curve for the total resulting polymer product, that curve will show two maxima or at least be distinctly broadened in comparison with the curves for the individual fractions. Such a polymer product is called bimodal. It is to be noted here that also the chemical compositions of the two fractions may be different.

Similarly the term “unimodal polymer” refers to a polymer comprising one main fraction and more specifically to the form of the polymers molecular weight distribution curve, i.e., the molecular weight distribution curve for the total polymer product shows only a single maximum.

As used herein, a “blend composition” can be a physical mixture of components A and B and/or a reaction product produced by a reaction between components A and B.

As used herein, the term “ionomer precursor composition” is a composition containing one or more alpha olefin/unsaturated carboxylic acid polymers and/or alpha olefin/unsaturated carboxylicacid/c unsaturated carboxylic acid ester terpolymers, mixed with one or more basic metal or non-metal salts capable of neutralizing the acid groups in the acid polymer.

The term “sports equipment” refers to any item of sports equipments such as sports clothing, boots, sneakers, clogs, sandals, slip on sandals and shoes, golf shoes, tennis shoes, running shoes, athletic shoes, hiking shoes, skis, ski masks, ski boots, cycling shoes, soccer boots, golf clubs, golf bags, and the like.

The singular terms “a,” “an,” and “the” include plural referents unless context clearly indicates otherwise. The word “comprises” indicates “includes.” It is further to be understood that all molecular weight or molecular mass values given for compounds are approximate, and are provided for description. The materials, methods, and examples are illustrative only and not intended to be limiting. Unless otherwise indicated, description of components in chemical nomenclature refers to the components at the time of addition to any combination specified in the description, but does not necessarily preclude chemical interactions among the components of a mixture once mixed.

Any numerical values recited herein include all values from the lower value to the upper value in increments of one unit provided that there is a separation of at least 2 units between any lower value and any higher value. As an example, if it is stated that the amount of a component or a value of a process variable is from 1 to 90, preferably from 20 to 80, more preferably from 30 to 70, it is intended that values such as 15 to 85, 22 to 68, 43 to 51, 30 to 32 etc., are expressly enumerated in this specification. For values, which have less than one unit difference, one unit is considered to be 0.1, 0.01, 0.001, or 0.0001 as appropriate. Thus all possible combinations of numerical values between the lowest value and the highest value enumerated herein are said to be expressly stated in this application.

The present invention can be used in forming golf balls of any desired size. “The Rules of Golf” by the USGA dictate that the size of a competition golf ball must be at least 1.680 inches in diameter; however, golf balls of any size can be used for leisure golf play. The preferred diameter of the golf balls is from about 1.680 inches to about 1.800 inches. The more preferred diameter is from about 1.680 inches to about 1.760 inches. A diameter of from about 1.680 inches to about 1.740 inches is most preferred; however diameters anywhere in the range of from 1.70 to about 2.0 inches can be used. Oversize golf balls with diameters above about 1.760 inches to as big as 2.75 inches are also within the scope of the invention.

### Multi-Functional Modifier

The multi-functional modifier includes at least one carboxyl functional group and at least two additional types of functional groups. Illustrative additional functional groups include hydroxyl, isocyanate, acid anhydride, and/or amino (primary, secondary or tertiary). In preferred embodiments, the two additional functional groups are hydroxyl and amino. In certain embodiments, the multi-functional modifier is an aliphatic carboxylic acid, aliphatic polycarboxylic acid, an aromatic carboxylic acid or an aromatic polycarboxylic acid that is substituted with at least two additional types of functional groups, particularly hydroxyl and amino. Examples of aliphatic carboxylic acids are alkanoic acids of the structure R¹COOH, wherein R¹ is a C₁-C₂₀ alkyl group, more particularly a C₁-C₆ alkyl group, that is substituted with at least two additional types of functional groups. An example of an aromatic carboxylic acid is benzoic acid substituted with at least two additional types of functional groups. A further example is an amino acid substituted with at least one further type of functional group, preferably a hydroxyl group, in addition to the carboxyl group and the amino group. Illustrative multi-functional modifiers include, but are not limited to, 4-amino-2-hydroxybenzoic acid; 2-amino-5-hydroxybenzoic acid; 3-amino-4-hydroxybenzoic acid; 4-amino-3-hydroxybenzoic acid; 4-amino-3-hydroxybutyric acid; 4-amino-2-hydroxybutyric acid; metal or non-metal salts thereof as described below; and combinations thereof.

In certain embodiments, a metal or non-metal salt of the multi-functional modifier agent may be used. For example, the metal salts may be carboxylic acid salts (—C(O)O⁻M⁺) or zwitterionic salts (⁻YR′₂HN⁺—R″—C(O)O⁻M⁺, wherein R′ is H or a C₁-C₂₀ aliphatic moiety and R″ is a C₁-C₂₀ aliphatic moiety or aromatic moiety, provided that at least one of R′ or R″ is substituted with at least one further type of functional group). The M⁺ ion may be selected from one or more of Li⁺, Na⁺, K⁺, Zn²⁺, Ca²⁺, Co²⁺, Ni²⁺, Cu²⁺, Pb²⁺, and Mg²⁺, and the ⁻Y ion may be selected from Cl⁻, Br⁻, I⁻, or ClO₄⁻. The non-metal salts have an ammonium cation having the general formula [NR¹R²R³R⁴]⁺ where R¹, R², R³ and R⁴ includes one or more of hydrogen, a C₁-C₂₀ aliphatic, cycloaliphatic or aromatic moiety.

### Ionomers

Ionomers useful for modification with a multi-functional modifier include unimodal ionomers that consist of a polymer of a mono-olefin, e.g., an alkene, with an unsaturated mono- or dicarboxylic acids having 3 to 12 carbon atoms. An additional monomer in the form of a mono- or dicarboxylic acid ester may also be incorporated in the formulation as a so-called “softening comonomer”. The incorporated carboxylic acid groups are then neutralized by a basic metal ion salt, to form the ionomer. The metal cations of the basic metal ion salt used for neutralization include Li⁺, Na⁺, Zn²⁺, Ca²⁺, Co²⁺, Ni²⁺, Cu²⁺, Pb²⁺, and Mg²⁺, with the Li⁺, Na⁺, Ca²⁺, Zn²⁺, and Mg²⁺ being preferred. The basic metal ion salts include those of for example formic acid, acetic acid, nitric acid, and carbonic acid, hydrogen carbonate salts, oxides, hydroxides, and alkoxides.

The first commercially available ionomer resins contained up to 16 weight percent acrylic or methacrylic acid, although it was also well known at that time that, as a general rule, the hardness of these cover materials could be increased with increasing acid content. Hence, in Research Disclosure 29703, published in January 1989, DuPont disclosed ionomers based on ethylene/acrylic acid or ethylene/methacrylic acid containing acid contents of greater than 15 weight percent. In this same disclosure, DuPont also taught that such so called “high acid ionomers” had significantly improved stiffness and hardness and thus could be advantageously used in golf ball construction, when used either singly or in a blend with other ionomers.

More recently, high acid ionomers are typically defined as those ionomer resins with acrylic or methacrylic acid units present from 16 wt. % to about 35 wt. % in the polymer. Generally, such a high acid ionomer will have a flexural modulus from about 50,000 psi to about 125,000 psi.

Ionomer resins further comprising a softening comonomer, present from about 10 wt, % to about 50 wt. % in the polymer, have a flexural modulus from about 2,000 psi to about 10,000 psi, and are sometimes referred to as “soft” or “very low modulus” ionomers. Typical softening comonomers include n-butyl acrylate, iso-butyl acrylate, n-butyl methacrylate, methyl acrylate and methyl methacrylate.

Today, there are a wide variety of commercially available ionomer resins based both on copolymers of ethylene and (meth)acrylic acid or terpolymers of ethylene and (meth)acrylic acid and (meth)acrylate, all of which many of which are be used as a golf ball component. The properties of these ionomer resins can vary widely due to variations in acid content, softening comonomer content, the degree of neutralization, and the type of metal ion used in the neutralization. The full range commercially available typically includes ionomers of polymers of general formula, E/X/Y polymer, wherein E is ethylene, X is a C₃ to C₈ α,β ethylenically unsaturated carboxylic acid, such as acrylic or methacrylic acid, and is present in an amount from about 2 to about 30 weight % of the E/X/Y copolymer, and Y is a softening comonomer selected from the group consisting of alkyl acrylate and alkyl methacrylate, such as methyl acrylate or methyl methacrylate, and wherein the alkyl groups have from 1-8 carbon atoms, Y is in the range of 0 to about 50 weight % of the E/X/Y copolymer, and wherein the acid groups present in said ionomeric polymer are partially neutralized with a metal selected from the group consisting of zinc, sodium, lithium, calcium, magnesium, and combinations thereof.

E/X/Y, where E is ethylene, X is a softening comonomer such as present in an amount of from 0 wt. % to about 50 wt, % of the polymer, and Y is present in an amount from about 5 wt. % to about 35 wt. % of the polymer, and wherein the acid moiety is neutralized from about 1% to about 90% to form an ionomer with a cation such as lithium, sodium, potassium, magnesium, calcium, barium, lead, tin, zinc or aluminum, or a combination of such cations.

The ionomer may also be a so-called bimodal ionomer as described in U.S. Pat. No. 6,562,906 (the entire contents of which are herein incorporated by reference). These ionomers are bimodal as they are prepared from blends comprising polymers of different molecular weights. Specifically they include bimodal polymer blend compositions comprising:
a high molecular weight component having a weight average molecular weight, Mw, of about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers; said high molecular weight component being partially neutralized with metal ions selected from the group consisting of lithium, sodium, zinc, calcium, magnesium, and a mixture of any these; and
b) a low molecular weight component having a weight average molecular weight, Mw, of about from about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers; said low molecular weight component being partially neutralized with metal ions selected from the group consisting of lithium, sodium, zinc, calcium, magnesium, and a mixture of any these.

In addition to the unimodal and bimodal ionomers, also included are the so-called “modified ionomers” examples of which are described in U.S. Pat. Nos. 6,100,321, 6,329,458 and 6,616,552 and U.S. Patent Publication US 2003/0158312 A1, the entire contents of all of which are herein incorporated by reference.

The modified unimodal ionomers may be prepared by mixing:
a) an ionomeric polymer comprising ethylene, from 5 to 25 weight percent (meth)acrylic acid, and from 0 to 40 weight percent of a (meth)acrylate monomer, said ionomeric polymer neutralized with metal ions selected from the group consisting of lithium, sodium, zinc, calcium, magnesium, and a mixture of any of these; and
b) from about 5 to about 40 weight percent (based on the total weight of said modified ionomeric polymer) of one or more fatty acids or metal salts of said fatty acid, the metal selected from the group consisting of calcium, sodium, zinc, potassium, and lithium, barium and magnesium and the fatty acid preferably being stearic acid.

The modified bimodal ionomers, which are ionomers derived from the earlier described bimodal ethylene/carboxylic acid polymers (as described in U.S. Pat. No. 6,562,906, the entire contents of which are herein incorporated by reference), are prepared by mixing;
a) a high molecular weight component having a weight average molecular weight, Mw, of about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers; said high molecular weight component being partially neutralized with metal ions selected from the group consisting of lithium, sodium, zinc, calcium, potassium, magnesium, and a mixture of any of these; and
b) a low molecular weight component having a weight average molecular weight, Mw, of about from about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers; said low molecular weight component being partially neutralized with metal ions selected from the group consisting of lithium, sodium, zinc, calcium, potassium, magnesium, and a mixture of any of these; and
c) from about 5 to about 40 weight percent (based on the total weight of said modified ionomeric polymer) of one or more fatty acids or metal salts of said fatty acid, the metal selected from the group consisting of calcium, sodium, zinc, potassium and lithium, barium and magnesium and the fatty acid preferably being stearic acid.

The fatty or waxy acid salts utilized in the various modified ionomers are composed of a chain of alkyl groups containing from about 4 to 75 carbon atoms (usually even numbered) and characterized by a —COOH terminal group. The generic formula for all fatty and waxy acids above acetic acid is CH₃(CH₂)_{X}COOH, wherein the carbon atom count includes the carboxyl group. The fatty or waxy acids utilized to produce the fatty or waxy acid salts modifiers may be saturated or unsaturated, and they may be present in solid, semi-solid or liquid form.

Examples of suitable saturated fatty acids, i.e., fatty acids in which the carbon atoms of the alkyl chain are connected by single bonds, include but are not limited to stearic acid (C₁₈, i.e., CH₃(CH₂)₁₆COOH), palmitic acid (C₁₆, i.e., CH₃(CH₂)₁₄COOH), pelargonic acid (C₉, i.e., CH₃(CH₂)₇COOH) and lauric acid (C₁₂, i.e., CH₃(CH₂)₁₀OCOOH). Examples of suitable unsaturated fatty acids, i.e., a fatty acid in which there are one or more double bonds between the carbon atoms in the alkyl chain, include but are not limited to oleic acid (C₁₃, i.e., CH₃(CH₂)₇CH:CH(CH₂)₇COOH).

The source of the metal ions used to produce the metal salts of the fatty or waxy acid salts used in the various modified ionomers are generally various metal salts which provide the metal ions capable of neutralizing, to various extents, the carboxylic acid groups of the fatty acids. These include the sulfate, carbonate, acetate and hydroxylate salts of zinc, barium, calcium and magnesium.

Since the fatty acid salts modifiers comprise various combinations of fatty acids neutralized with a large number of different metal ions, several different types of fatty acid salts may be utilized in the invention, including metal stearates, laureates, oleates, and palmitates, with calcium, zinc, sodium, lithium, potassium and magnesium stearate being preferred, and calcium and sodium stearate being most preferred.

The fatty or waxy acid or metal salt of said fatty or waxy acid is present in the modified ionomeric polymers in an amount of from about 5 to about 40, preferably from about 7 to about 35, more preferably from about 8 to about 20 weight percent (based on the total weight of said modified ionomeric polymer).

As a result of the addition of the one or more metal salts of a fatty or waxy acid, from about 40 to 100, preferably from about 50 to 100, more preferably from about 70 to 100 percent of the acidic groups in the final modified ionomeric polymer composition are neutralized by a metal ion.

An example of such a modified ionomer polymer is DuPont® HPF-1000 available from E.I DuPont de Nemours and Co. Inc.

### Addition of Multi-Functional Modifiers to Ionomers

The multi-functional modifiers advantageously can be used to change the properties of an ionomer, and particularly to provide a polyurethane ionomer as described below in more detail. For example, hardness and/or flexural modulus can be increased, while substantially maintaining beneficial processing characteristics, such as material flow. Without being bound by a theory of operation, effective amounts of a multi-functional modifier(s) may interact with ionomer(s) as exemplified below.

The multi-functional modifier may be reacted with an ionomer. In certain embodiments, amino groups present in the multi-functional modifier react with at a portion of available acid functional groups, such as carboxyl or carboxylate functional groups, present in the ionomer to form an amide bond. The resulting product of the blending, preferably reacting, of the multi-functional modifier with the ionomer is referred to herein as a “multi-functional modified ionomer.” In certain embodiments, the acid content (by weight or mol) of the multi-functional modifier ionomer is the same as the acid content of the starting ionomer because the multi-functional modifier includes acid functional groups that are introduced into the modified ionomer structure and, in effect, replace the acid functional groups of the starting ionomer that react with amino groups of the multi-functional modifier. In other embodiments, the acid content (by weight or mol) of the multi-functional modifier ionomer is greater than the acid content of the starting ionomer because the multi-functional modifier includes a greater number of acid functional groups than the number of acid functional groups in the starting ionomer that are reacted with the multi-functional modifier. In further embodiments, the acid content (by weight or mol) of the multi-functional modifier ionomer is less than the acid content of the starting ionomer because the multi-functional modifier includes a smaller number of acid functional groups than the number of acid functional groups in the starting ionomer that are reacted with the multi-functional modifier.

In other approaches, the multi-functional modifier may be blended with an ionomer(s) to form an intermediate polymer blend composition. The intermediate polymer blend composition may then be blended with a non-ionomer polymer(s), such as a block copolymer as described below, to form a final polymer blend composition. In an alternative approach, an ionomer(s) may be blended with a non-ionomer polymer(s), such as a block copolymer as described below, to form an intermediate polymer blend composition. The intermediate polymer blend composition may then be blended with a multi-functional modifier to form a final polymer blend composition.

### Polyurethane Ionomers

The multi-functional modified ionomer can be used to make a polyurethane ionomer by any one of the following routes:

(1) (a) Reacting the multi-functional modified ionomer with an isocyanate to make a polyurethane; and (b) partially or fully neutralizing the polyurethane with metal or non-metal cations to make a polyurethane ionomer; or

(2) (a) Partially or fully neutralizing the multi-functional modified ionomer with metal or non-metal cations; and (b) reacting the partially or fully-neutralized multi-functional modified ionomer with an isocyanate to make a polyurethane ionomer.

A polyurethane ionomer/block copolymer blend can be made by:

(1) (a) Blending the multi-functional modified ionomer with a block copolymer; b) reacting the multi-functional modified ionomer in the blend with an isocyanate to make a polyurethane; and (c) neutralizing the polyurethane with metal or non-metal cations to make a polyurethane ionomer/block copolymer blend; or

(2) (a) Reacting the multi-functional modified ionomer with an isocyanate to make a polyurethane, (b) blending the polyurethane with a block copolymer; and (c) neutralizing the polyurethane with metal or non-metal cations to make a polyurethane ionomer/block copolymer blend.

According to methods (1) or (2) above, the multi-functional modified ionomer may be reacted with at least one isocyanate resulting in formation of a polyurethane. In particular, hydroxyl functional groups of the multi-functional modified ionomer react with the isocyanate functional groups. If any of the residual acidic groups from the multi-functional modified ionomer are neutralized with a metal cation, the resulting product is a polyurethane ionomer. The acidic groups in the multi-functional modified ionomer may be neutralized prior to reaction with the isocyanate. In addition, the carbamate groups in the resulting polyurethane, or any residual ester or acid groups in the resulting polyurethane, may be neutralized as described above after reaction with the isocyanate. The urethane ionomer can advantageously combine the properties of an ionomer with the properties of a urethane.

Isocyanates used to make polyurethane ionomers from the multi-functional modified ionomer according to the present disclosure encompass diisocyanates and polyisocyanates. Useful isocyanates include aliphatic, arylaliphatic, alicyclic and aromatic isocyanates. The isocyanate content of such compounds can vary, but typically is greater than about 20%, more typically greater than about 25%, even more typically from about 25% to about 35%, and preferably from about 29% to about 34%. Suitable isocyanate-containing components include diisocyanates having the generic structure: O═C═N—R—N═C═O, where R preferably is a cyclic, aromatic, or linear or branched hydrocarbon moiety containing from about 1 to about 50 carbon atoms. The isocyanate also may contain one or more cyclic groups or one or more phenyl groups. When multiple cyclic or aromatic groups are present, linear and/or branched hydrocarbons containing from about 1 to about 10 carbon atoms can be present as spacers between the cyclic or aromatic groups. In some cases, the cyclic or aromatic group(s) may be substituted at the 2-, 3-, and/or 4-positions, or at the ortho-, meta-, and/or para-positions, respectively. Substituted groups may include, but are not limited to, halogens, primary, secondary, or tertiary hydrocarbon groups, or a mixture thereof. Isocyanates for use with the present invention include, but are not limited to, aliphatic, cycloaliphatic, aromatic aliphatic, aromatic, any derivatives thereof, and combinations of these compounds having two or more isocyanate (NCO) groups per molecule each a polyisocyanate (with a diisocyanate being a specific polyisocyanate with two isocyanate groups). As used herein, aromatic aliphatic compounds should be understood as those containing an aromatic ring, wherein the isocyanate group is not directly bonded to the ring. One example of an aromatic aliphatic compound is a tetramethylene diisocyanate (TMXDI). The isocyanates may be organic polyisocyanate-terminated prepolymers, free isocyanate prepolymer, and mixtures thereof. The isocyanate-containing reactable component also may include any isocyanate-functional monomer, dimer, trimer, or polymeric adduct thereof, prepolymer, quasi-prepolymer, or mixtures thereof. Isocyanate-functional compounds may include monoisocyanates or polyisocyanates that include any isocyanate functionality of two or more.

Examples of polyisocyanates that can be used include, but are not limited to, substituted and isomeric mixtures including 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric or oligomeric MDI; polymeric or oligomeric (e.g., dimeric) TDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); trimer of IPDI; dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclohexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, triphenylmethane 4,4′,4″-triisocyanate, isocyanatoethyl methacrylate, 3-isopropenyl-α,α-dimethylbenzyl-isocyanate, dichlorohexamethylene diisocyanate, w, d-diisocyanato-1,4-diethylbenzene, polymethylene polyphenylene polyisocyanate, isocyanurate modified compounds, and carbodiimide modified compounds, as well as biuret modified compounds of the above polyisocyanates. These isocyanates may be used either alone or in combination. These combination isocyanates include triisocyanates, such as biuret of hexamethylene diisocyanate and triphenylmethane triisocyanates, and polyisocyanates, such as polymeric diphenylmethane diisocyanate.triisocyanate of HDI; triisocyanate of 2,2,4-trimethyl-1,6-hexane diisocyanate (TMDI); 4,4′-dicyclohexylmethane diisocyanate (H₁₂MDI); 2,4-hexahydrotoluene diisocyanate; 2,6-hexahydrotoluene diisocyanate; 1,2-, 1,3-, and 1,4-phenylene diisocyanate; aromatic aliphatic isocyanate, such as 1,2-, 1,3-, and 1,4-xylene diisocyanate; meta-tetramethylxylene diisocyanate (m-TMXDI); para-tetramethylxylene diisocyanate (p-TMXDI); trimerized isocyanurate of any polyisocyanate, such as isocyanurate of toluene diisocyanate, trimer of diphenylmethane diisocyanate, trimer of tetramethylxylene diisocyanate, isocyanurate of hexamethylene diisocyanate, and mixtures thereof, dimerized uretdione of any polyisocyanate, such as uretdione of toluene diisocyanate, uretdione of hexamethylene diisocyanate, and mixtures thereof; modified polyisocyanate derived from the above isocyanates and polyisocyanates; and mixtures thereof.

Also included as possible reactants with the multi-functional modified ionomer according to the present disclosure are the so-called blocked isocyanates, in which the isocyanate groups are preferably blocked as a result of the reaction of a suitable isocyanate with a blocking agent. The blocking agent may be any suitable blocking agent that results in the prevention of premature polymerization or crosslinking of the isocyanate groups.

Suitable blocking agents include, but are not limited to, linear and branched alcohols; phenols and derivatives thereof, such as xylenol; oximes, such as methyl ethyl ketoxime; lactams, such as ε-caprolactam; lactones, such as caprolactone; β-dicarbonyl compounds; hydroxamic acid esters; bisulfite addition compounds; hydroxylamines; esters of p-hydroxybenzoic acid; N-hydroxyphthalimide; N-hydroxysuccinimide; triazoles; substituted imidazolines; tetrahydropyrimidines; caprolactones; and mixtures thereof. In one embodiment, the blocking agent is selected from the group consisting of phenols, branched alcohols, methyl ethyl ketoxime, ε-caprolactam, ε-caprolactone, and mixtures thereof.

In this aspect of the invention, preferably greater than about 80 percent of the isocyanate radicals are blocked, and more preferably about 90 percent or greater of the isocyanate radicals are blocked. In one embodiment, about 95 percent or more of the isocyanate radicals are blocked. In another embodiment, about 97 percent or more of the isocyanate radicals are blocked. In still another embodiment, substantially all of the isocyanate radicals are blocked.

The blocked isocyanate compound is stable at room temperature as for example a carbamic acid compound free of isocyanate radicals capable of liberating at room temperature. When heated, or reacted with a “deblocking” agent, the isocyanate radicals are activated, i.e., deblocked and dissociated. For example, in one embodiment, the isocyanate group(s) is blocked with ε-caprolactone. The ε-caprolactone volatilizes at a temperature of approximately 300° F., exposing the polyisocyanate groups for crosslinking. Also included are the blocked isocyanates disclosed in Kim et al. in U.S. Pat. No. 6,939,924, the entire contents of which are hereby incorporated by reference, The blocked isocyanates suitable for use as the crosslinking agent in the present invention include isophorone diisocyanate (IPDI)-based uretdione-type crosslinkers; a combination of a uretdione adduct of IPDI and a partially ε-caprolactam-modified IPDI; a combination of isocyanate adducts modified by ε-caprolactam and a carboxylic acid functional group; a caprolactam-modified Desmodur diisocyanate; a Desmodur diisocyanate having a 3,5-dimethylpyrazole modified isocyanate; and any and all mixtures of these.

The resulting polyurethane polymer that includes acidic functional groups from the multi-functional modified ionomer may be neutralized with i) a basic metal ion salt having a cation which includes one or more of Li⁺, Na⁺, K⁺, Zn²⁺, Ca²⁺, Co²⁺, Ni²⁺, Cu²⁺, Pb²⁺, and Mg²⁺and a counterion which includes one or more of formates, acetates, nitrates, sulfates, chlorides, carbonates, hydrogen carbonates, oxides, hydroxides, and alkoxides or ii) a basic non-metal ion salt having an ammonium cation having the general formula [NR¹R²R³R⁴]⁺ where R¹, R², Wand R⁴ includes one or more of hydrogen, a C₁-C₂₀ aliphatic, cycloaliphatic or aromatic moiety and any and all combination thereof; and a counterion which includes one or more of formates, acetates, nitrates, sulfates, chlorides, carbonates, hydrogen carbonates, oxides, hydroxides, and alkoxides. The resulting product is a polyurethane ionomer.

Illustrative block copolymers for use in the above-described methods include styrenic block copolymers including styrene-butadiene-styrene (SBS), styrene-ethylene-butylene-styrene, (SEBS) and styrene-ethylene/propylene-styrene (SEPS). Also included are functionalized styrenic block copolymers, including those where the block copolymer incorporates a first polymer block having an aromatic vinyl compound, a second polymer block having a conjugated diene compound and a hydroxyl group located at a block copolymer, or its hydrogenation product, and in which the ratio of block copolymer to ionomer ranges from 5:95 to 95:5 by weight, more preferably from about 10:90 to about 90:10 by weight, more preferably from about 20:80 to about 80:20 by weight, more preferably from about 30:70 to about 70:30 by weight and most preferably from about 35:65 to about 65:35 by weight. A preferred functionalized styrenic block copolymer is SEPTON HG-252. Such blends are described in more detail in commonly-assigned U.S. Pat. No. 6,861,474 and U.S. Patent Publication No. 2003/0224871 both of which are incorporated herein by reference in their entireties.

### Additional Polymer Components

The golf balls of the present disclosure may include one or more of the following additional polymers generally considered useful for making golf balls as either an additional blend component or as one or more of the components of the golf balls including the cover layer, intermediate layer(s) and core. These polymers include, without limitation, synthetic and natural rubbers, thermoset polymers such as other thermoset polyurethanes or thermoset polyureas, as well as thermoplastic polymers including thermoplastic elastomers such as thermoplastic polyurethanes or thermoplastic polyureas, metallocene catalyzed polymers, unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, polyamides, copolyamides, polyesters, copolyesters, polycarbonates, polyolefins, halogenated polyolefins, such as halogenated polyethylene [e.g. chlorinated polyethylene (CPE)], halogenated polyalkylene compounds, polyalkenamer, polyphenylene oxides, polyphenylene sulfides, diallyl phthalate polymers, polyimides, polyvinyl chlorides, polyamide-ionomers, polyurethane-ionomers, polyvinyl alcohols, polyarylates, polyacrylates, polyphenylene ethers, impact-modified polyphenylene ethers, polystyrenes, high impact polystyrenes, acrylonitrile-butadiene-styrene copolymers, styrene-acrylonitriles (SAN), acrylonitrile-styrene-acrylonitriles, styrene-maleic anhydride (S/MA) polymers, styrenic block copolymers including styrene-butadiene-styrene (SBS), styrene-ethylene-butylene-styrene, (SEBS) and styrene-ethylene-propylene-styrene (SEPS), styrenic terpolymers, functionalized styrenic block copolymers including hydroxylated, functionalized styrenic copolymers, and terpolymers, cellulosic polymers, liquid crystal polymers (LCP), ethylene-propylene-diene terpolymers (EPDM), ethylene-vinyl acetate copolymers (EVA), ethylene-propylene copolymers, propylene elastomers (such as those described in U.S. Pat. No. 6,525,157, to Kim et al, the entire contents of which is hereby incorporated by reference in its entirety), ethylene vinyl acetates and polysiloxanes, and any and all combinations thereof.

One preferred material which may be used as a component of the outer cover layer and/or intermediate layers of the golf balls of the present invention comprises a blend of an ionomer and a block copolymer. Examples of such block copolymers include styrenic block copolymers including styrene-butadiene-styrene (SBS), styrene-ethylene-butylene-styrene, (SEBS) and styrene-ethylene/propylene-styrene (SEPS). Also included are functionalized styrenic block copolymers, including those where the block copolymer incorporates a first polymer block having an aromatic vinyl compound, a second polymer block having a conjugated diene compound and a hydroxyl group located at a block copolymer, or its hydrogenation product, and in which the ratio of block copolymer to ionomer ranges from 5:95 to 95:5 by weight, more preferably from about 10:90 to about 90:10 by weight, more preferably from about 20:80 to about 80:20 by weight, more preferably from about 30:70 to about 70:30 by weight and most preferably from about 35:65 to about 65:35 by weight. A preferred functionalized styrenic block copolymer is SEPTON HG-252. Such blends are described in more detail in commonly-assigned U.S. Pat. No. 6,861,474 and U.S. Patent Publication No. 2003/0224871 both of which are incorporated herein by reference in their entireties.

Another preferred material for the outer cover and/or intermediate layers of the golf balls of the present invention is a composition prepared by blending together at least three materials, identified as Components A, B, and C, and melt-processing these components to form in-situ, a polymer blend composition incorporating a pseudo-crosslinked polymer network. Such blends are described in more detail in commonly-assigned U.S. Pat. No. 6,930,150, to Kim et al, the content of which is incorporated by reference herein in its entirety. Component A is a monomer, oligomer, prepolymer or polymer that incorporates at least five percent by weight of at least one type of an acidic functional group. Examples of such polymers suitable for use as include, but are not limited to, ethylene/(meth)acrylic acid copolymers and ethylene/(meth)acrylic acid/alkyl(meth)acrylate terpolymers, or ethylene and/or propylene maleic anhydride copolymers and terpolymers. Examples of such polymers which are commercially available include, but are not limited to, the Escor® 5000, 5001, 5020, 5050, 5070, 5100, 5110 and 5200 series of ethylene-acrylic acid copolymers sold by Exxon and the PRIMACOR® 1321, 1410, 1410-XT, 1420, 1430, 2912, 3150, 3330, 3340, 3440, 3460, 4311, 4608 and 5980 series of ethylene-acrylic acid copolymers sold by The Dow Chemical Company, Midland, Mich. and the ethylene-acrylic acid copolymers Nucrel 599, 699, 0903, 0910, 925, 960, 2806, and 2906 ethylene-methacrylic acid copolymers. sold by DuPont Also included are the bimodal ethylene/carboxylic acid polymers as described in U.S. Pat. No. 6,562,906, the contents of which are incorporated herein by reference. These polymers comprise ethylene/α,β-ethylenically unsaturated C₃₋₈ carboxylic acid high copolymers, particularly ethylene (meth)acrylic acid copolymers and ethylene, alkyl(meth)acrylate, (meth)acrylic acid terpolymers, having molecular weights of about 80,000 to about 500,000 which are melt blended with ethylene/α,β-ethylenically unsaturated C₃₋₈ carboxylic acid copolymers, particularly ethylene/(meth)acrylic acid copolymers having molecular weights of about 2,000 to about 30,000.

Component B can be any monomer, oligomer, or polymer, preferably having a lower weight percentage of anionic functional groups than that present in Component A in the weight ranges discussed above, and most preferably free of such functional groups. Examples of materials for use as Component B include block copolymers such as styrenic block copolymers including styrene-butadiene-styrene (SBS), styrene-ethylene-butylene-styrene, (SEBS) and styrene-ethylene/propylene-styrene (SEPS). Also included are functionalized styrenic block copolymers, including those where the block copolymer incorporates a first polymer block having an aromatic vinyl compound, a second polymer block having a conjugated diene compound and a hydroxyl group located at a block copolymer, or its hydrogenation product. Commercial examples SEPTON marketed by Kuraray Company of Kurashiki, Japan; TOPRENE by Kumho Petrochemical Co., Ltd and KRATON marketed by Kraton Polymers.

Component C is a base capable of neutralizing the acidic functional group of Component A and is a base having a metal cation. These metals are from groups IA, IB, IIA, IIB, IIIA, IIIB, NA, IVB, VA, VB, VIIA, VIIB, VIIB and VIIIB of the periodic table. Examples of these metals include lithium, sodium, magnesium, aluminum, potassium, calcium, manganese, tungsten, titanium, iron, cobalt, nickel, hafnium, copper, zinc, barium, zirconium, and tin. Suitable metal compounds for use as a source of Component C are, for example, metal salts, preferably metal hydroxides, metal oxides, metal carbonates, or metal acetates.

The composition preferably is prepared by mixing the above materials into each other thoroughly, either by using a dispersive mixing mechanism, a distributive mixing mechanism, or a combination of these. These mixing methods are well known in the manufacture of polymer blends. As a result of this mixing, the anionic functional group of Component A is dispersed evenly throughout the mixture. Most preferably, Components A and B are melt-mixed together without Component C, with or without the premixing discussed above, to produce a melt-mixture of the two components. Then, Component C separately is mixed into the blend of Components A and B. This mixture is melt-mixed to produce the reaction product. This two-step mixing can be performed in a single process, such as, for example, an extrusion process using a proper barrel length or screw configuration, along with a multiple feeding system.

Another preferred material for the cover and/or one or intermediate layers of the golf balls of the present disclosure is a blend of a homopolyamide or copolyamide modified and a polymer including a grafted maleic anhydride group.

Another preferred material which may be used as a component of the cover layer and/or intermediate layer of the golf balls of the present disclosure is the family of polyurethanes or polyureas which are typically are prepared by reacting a diisocyanate with a polyol (in the case of polyurethanes) or with a polyamine (in the case of a polyurea). Thermoplastic polyurethanes or polyureas may consist solely of this initial mixture or may be further combined with a chain extender to vary properties such as hardness of the thermoplastic. Thermoset polyurethanes or polyureas typically are formed by the reaction of a diisocyanate and a polyol or polyamine respectively, and an additional crosslinking agent to crosslink or cure the material to result in a thermoset.

In what is known as a one-shot process, the three reactants, diisocyanate, polyol or polyamine, and optionally a chain extender or a curing agent, are combined in one step. Alternatively, a two-step process may occur in which the first step involves reacting the diisocyanate and the polyol (in the case of polyurethane) or the polyamine (in the case of a polyurea) to form a so-called prepolymer, to which can then be added either the chain extender or the curing agent. This procedure is known as the prepolymer process.

In addition, although depicted as discrete component packages as above, it is also possible to control the degree of crosslinking, and hence the degree of thermoplastic or thermoset properties in a final composition, by varying the stoichiometry not only of the diisocyanate-to-chain extender or curing agent ratio, but also the initial diisocyanate-to-polyol or polyamine ratio. Of course in the prepolymer process, the initial diisocyanate-to-polyol or polyamine ratio is fixed on selection of the required prepolymer.

In addition to discrete thermoplastic or thermoset materials, it also is possible to modify thermoplastic polyurethane or polyurea compositions by introducing materials in the composition that undergo subsequent curing after molding the thermoplastic to provide properties similar to those of a thermoset. For example, Kim in U.S. Pat. No. 6,924,337, the entire contents of which are hereby incorporated by reference, discloses a thermoplastic urethane or urea composition optionally comprising chain extenders and further comprising a peroxide or peroxide mixture, which can then undergo post curing to result in a thermoset.

Also, Kim et al. in U.S. Pat. No. 6,939,924, the entire contents of which are hereby incorporated by reference, discloses a thermoplastic urethane or urea composition, optionally also comprising chain extenders, that are prepared from a diisocyanate and a modified or blocked diisocyanate which unblocks and induces further cross linking post extrusion. The modified isocyanate preferably is selected from the group consisting of: isophorone diisocyanate (IPDI)-based uretdione-type crosslinker; a combination of a uretdione adduct of IPDI and a partially ε-caprolactam-modified IPDI; a combination of isocyanate adducts modified by ε-caprolactam and a carboxylic acid functional group; a caprolactam-modified Desmodur diisocyanate; a Desmodur diisocyanate having a 3,5-dimethylpyrazole modified isocyanate; or mixtures of these.

Finally, Kim et al. in U.S. Pat. No. 7,037,985 B2, the entire contents of which are hereby incorporated by reference, discloses thermoplastic urethane or urea compositions further comprising a reaction product of a nitroso compound and a diisocyanate or a polyisocyanate. The nitroso reaction product has a characteristic temperature at which it decomposes to regenerate the nitroso compound and diisocyanate or polyisocyanate. Thus, by judicious choice of the post-processing temperature, further crosslinking can be induced in the originally thermoplastic composition to provide thermoset-like properties.

Any isocyanate available to one of ordinary skill in the art is suitable for use in the polyurethanes or polyureas used in the present invention. Isocyanates for use with the present invention include, but are not limited to, aliphatic, cycloaliphatic, aromatic aliphatic, aromatic, any derivatives thereof, and combinations of these compounds having two or more isocyanate (NCO) groups per molecule. As used herein, aromatic aliphatic compounds should be understood as those containing an aromatic ring, wherein the isocyanate group is not directly bonded to the ring. One example of an aromatic aliphatic compound is a tetramethylene diisocyanate (TMXDI). The isocyanates may be organic polyisocyanate-terminated prepolymers, low free isocyanate prepolymer, and mixtures thereof. The isocyanate-containing reactable component also may include any isocyanate-functional monomer, dimer, trimer, or polymeric adduct thereof, prepolymer, quasi-prepolymer, or mixtures thereof. Isocyanate-functional compounds may include monoisocyanates or polyisocyanates that include any isocyanate functionality of two or more.

Suitable isocyanate-containing components include diisocyanates having the generic structure: O═C═N—R—N═C═O, where R preferably is a cyclic, aromatic, or linear or branched hydrocarbon moiety containing from about 1 to about 50 carbon atoms. The isocyanate also may contain one or more cyclic groups or one or more phenyl groups. When multiple cyclic or aromatic groups are present, linear and/or branched hydrocarbons containing from about 1 to about 10 carbon atoms can be present as spacers between the cyclic or aromatic groups. In some cases, the cyclic or aromatic group(s) may be substituted at the 2-, 3-, and/or 4-positions, or at the ortho-, meta-, and/or para-positions, respectively. Substituted groups may include, but are not limited to, halogens, primary, secondary, or tertiary hydrocarbon groups, or a mixture thereof.

Examples of isocyanates that can be used with the present invention include, but are not limited to, substituted and isomeric mixtures including 2,2′-, 2,4′-, and 4,4′-diphenylmethane diisocyanate (MDI); 3,3′-dimethyl-4,4′-biphenylene diisocyanate (TODD; toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclohexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, triphenylmethane 4,4′,4″-triisocyanate, isocyanatoethyl methacrylate, 3-isopropenyl-α,α-dimethylbenzyl-isocyanate, dichlorohexamethylene diisocyanate, ω,ω′-diisocyanato-1,4-diethylbenzene, polymethylene polyphenylene polyisocyanate, isocyanurate modified compounds, and carbodiimide modified compounds, as well as biuret modified compounds of the above polyisocyanates. These isocyanates may be used either alone or in combination. These combination isocyanates include triisocyanates, such as biuret of hexamethylene diisocyanate and triphenylmethane triisocyanates, and polyisocyanates, such as polymeric diphenylmethane diisocyanate.triisocyanate of HDI; triisocyanate of 2,2,4-trimethyl-1,6-hexane diisocyanate (TMDI); 4,4′-dicyclohexylmethane diisocyanate (H₁₂MDI); 2,4-hexahydrotoluene diisocyanate; 2,6-hexahydrotoluene diisocyanate; 1,2-, 1,3-, and 1,4-phenylene diisocyanate; aromatic aliphatic isocyanate, such as 1,2-, 1,3-, and 1,4-xylene diisocyanate; meta-tetramethylxylene diisocyanate (m-TMXDI); para-tetramethylxylene diisocyanate (p-TMXDI); trimerized isocyanurate of any polyisocyanate, such as isocyanurate of toluene diisocyanate, trimer of diphenylmethane diisocyanate, trimer of tetramethylxylene diisocyanate, isocyanurate of hexamethylene diisocyanate, and mixtures thereof, dimerized uretdione of any polyisocyanate, such as uretdione of toluene diisocyanate, uretdione of hexamethylene diisocyanate, and mixtures thereof; modified polyisocyanate derived from the above isocyanates and polyisocyanates; and mixtures thereof.

Any polyol now known or hereafter developed is suitable for use according to the invention. Polyols suitable for use in the present invention include, but are not limited to, polyester polyols, polyether polyols, polycarbonate polyols and polydiene polyols such as polybutadiene polyols.

Any polyamine available to one of ordinary skill in the polyurethane art is suitable for use according to the invention. Polyamines suitable for use in the compositions of the present invention include, but are not limited to, amine-terminated compounds typically are selected from amine-terminated hydrocarbons, amine-terminated polyethers, amine-terminated polyesters, amine-terminated polycaprolactones, amine-terminated polycarbonates, amine-terminated polyamides, and mixtures thereof. The amine-terminated compound may be a polyether amine selected from polytetramethylene ether diamines, polyoxypropylene diamines, poly(ethylene oxide capped oxypropylene)ether diamines, triethyleneglycoldiamines, propylene oxide-based triamines, trimethylolpropane-based triamines, glycerin-based triamines, and mixtures thereof.

The diisocyanate and polyol or polyamine components may be combined to form a prepolymer prior to reaction with a chain extender or curing agent. Any such prepolymer combination is suitable for use in the present invention.

One preferred prepolymer is a toluene diisocyanate prepolymer with polypropylene glycol. Such polypropylene glycol terminated toluene diisocyanate prepolymers are available from Uniroyal Chemical Company of Middlebury, Conn., under the trade name ADIPRENE® LFG963A and LFG640D. Most preferred prepolymers are the polytetramethylene ether glycol terminated toluene diisocyanate prepolymers including those available from Uniroyal Chemical Company of Middlebury, Conn., under the trade name ADIPRENE® LF930A, LF950A, LF601D, and LF751D.

In one embodiment, the number of free NCO groups in the urethane or urea prepolymer may be less than about 14 percent. Preferably the urethane or urea prepolymer has from about 3 percent to about 11 percent, more preferably from about 4 to about 9.5 percent, and even more preferably from about 3 percent to about 9 percent, free NCO on an equivalent weight basis.

Polyol chain extenders or curing agents may be primary, secondary, or tertiary polyols. Non-limiting examples of monomers of these polyols include: trimethylolpropane (TMP), ethylene glycol, 1,3-propanediol, 1,4-butanediol, 1,5-pentanediol, 1,6-hexanediol, propylene glycol, dipropylene glycol, 1,2-butanediol, 1,3-butanediol, 2,3-butanediol, 1,2-pentanediol, 2,3-pentanediol, 2,5-hexanediol, 2,4-hexanediol, 2-ethyl-1,3-hexanediol, cyclohexanediol, and 2-ethyl-2-(hydroxymethyl)-1,3-propanediol.

Diamines and other suitable polyamines may be added to the compositions of the present invention to function as chain extenders or curing agents. These include primary, secondary and tertiary amines having two or more amines as functional groups. Exemplary diamines include aliphatic diamines, such as tetramethylenediamine, pentamethylenediamine, hexamethylenediamine; alicyclic diamines, such as 3,3′-dimethyl-4,4′-diamino-dicyclohexyl methane; or aromatic diamines, such as diethyl-2,4-toluenediamine, 4,4″-methylenebis-(3-chloro, 2,6-diethyl)-aniline (available from Air Products and Chemicals Inc., of Allentown, Pa., under the trade name LONZACURE®), 3,3′-dichlorobenzidene; 3,3′-dichloro-4,4′-diaminodiphenyl methane (MOCA); N,N,N′,N′-tetrakis(2-hydroxypropyl)ethylenediamine, 3,5-dimethylthio-2,4-toluenediamine; 3,5-dimethylthio-2,6-toluenediamine; N,N′-dialkyldiamino diphenyl methane; trimethylene-glycol-di-p-aminobenzoate; polytetramethyleneoxide-di-p-aminobenzoate, 4,4′-methylene bis-2-chloroaniline, 2,2′,3,3′-tetrachloro-4,4′-diamino-phenyl methane, p,p′-methylenedianiline, p-phenylenediamine or 4,4′-diaminodiphenyl; and 2,4,6-tris(dimethylaminomethyl)phenol.

Depending on their chemical structure, curing agents may be slow- or fast-reacting polyamines or polyols. As described in U.S. Pat. Nos. 6,793,864, 6,719,646 and copending U.S. Patent Publication No. 2004/0201133 A 1, (the contents of all of which are hereby incorporated herein by reference), slow-reacting polyamines are diamines having amine groups that are sterically and/or electronically hindered by electron withdrawing groups or bulky groups situated proximate to the amine reaction sites. The spacing of the amine reaction sites will also affect the reactivity speed of the polyamines.

Suitable curatives for use in the present invention are selected from the slow-reacting polyamine group include, but are not limited to, 3,5-dimethylthio-2,4-toluenediamine; 3,5-dimethylthio-2,6-toluenediamine; N,N′-dialkyldiamino diphenyl methane; trimethylene-glycol-di-p-aminobenzoate; polytetramethyleneoxide-di-p-aminobenzoate, and mixtures thereof. Of these, 3,5-dimethylthio-2,4-toluenediamine and 3,5-dimethylthio-2,6-toluenediamine are isomers and are sold under the trade name ETHACURE® 300 by Ethyl Corporation. Trimethylene glycol-di-p-aminobenzoate is sold under the trade name POLACURE 740M and polytetramethyleneoxide-di-p-aminobenzoates are sold under the trade name POLAMINES by Polaroid Corporation. N,N′-dialkyldiamino diphenyl methane is sold under the trade name UNILINK® by UOP.

Also included as a curing agent for use in the polyurethane or polyurea compositions used in the present invention are the family of dicyandiamides as described in copending application Ser. No. 11/809,432 filed on May 31, 2007 by Kim et al., the entire contents of which are hereby incorporated by reference.

The cover layer and/or intermediate layers of the golf balls of the present disclosure may also comprise one or more ionomer resins. One family of such resins were developed in the mid-1960's, by E.I. DuPont de Nemours and Co., and sold under the trademark SURLYN®. Preparation of such ionomers is well known, for example see U.S. Pat. No. 3,264,272. Generally speaking, most commercial ionomers are unimodal and consist of a polymer of a mono-olefin, e.g., an alkene, with an unsaturated mono- or dicarboxylic acids having 3 to 12 carbon atoms. An additional monomer in the form of a mono- or dicarboxylic acid ester may also be incorporated in the formulation as a so-called “softening comonomer”. The incorporated carboxylic acid groups are then neutralized by a basic metal ion salt, to form the ionomer. The metal cations of the basic metal ion salt used for neutralization include Li⁺, Na⁺, Zn⁺, Ca⁺, Co⁺, Ni⁺, Cu⁺, Pb⁺, and Mg⁺, with the Li⁺, Na⁺, Ca⁺, Zn⁺, and Mg⁺ being preferred. The basic metal ion salts include those of for example formic acid, acetic acid, nitric acid, and carbonic acid, hydrogen carbonate salts, oxides, hydroxides, and alkoxides.

The first commercially available ionomer resins contained up to 16 weight percent acrylic or methacrylic acid, although it was also well known at that time that, as a general rule, the hardness of these cover materials could be increased with increasing acid content. Hence, in Research Disclosure 29703, published in January 1989, DuPont disclosed ionomers based on ethylene/acrylic acid or ethylene/methacrylic acid containing acid contents of greater than 15 weight percent. In this same disclosure, DuPont also taught that such so called “high acid ionomers” had significantly improved stiffness and hardness and thus could be advantageously used in golf ball construction, when used either singly or in a blend with other ionomers.

More recently, high acid ionomers are typically defined as those ionomer resins with acrylic or methacrylic acid units present from 16 wt. % to about 35 wt. % in the polymer. Generally, such a high acid ionomer will have a flexural modulus from about 50,000 psi to about 125,000 psi.

Ionomer resins further comprising a softening comonomer, present from about 10 wt. % to about 50 wt. % in the polymer, have a flexural modulus from about 2,000 psi to about 10,000 psi, and are sometimes referred to as “soft” or “very low modulus” ionomers. Typical softening comonomers include n-butyl acrylate, iso-butyl acrylate, n-butyl methacrylate, methyl acrylate and methyl methacrylate.

Today, there are a wide variety of commercially available ionomer resins based both on copolymers of ethylene and (meth)acrylic acid or terpolymers of ethylene and (meth)acrylic acid and (meth)acrylate, all of which many of which are be used as a golf ball component. The properties of these ionomer resins can vary widely due to variations in acid content, softening comonomer content, the degree of neutralization, and the type of metal ion used in the neutralization. The full range commercially available typically includes ionomers of polymers of general formula, E/X/Y polymer, wherein E is ethylene, X is a C₃ to C₈ α,β ethylenically unsaturated carboxylic acid, such as acrylic or methacrylic acid, and is present in an amount from about 2 to about 30 weight % of the E/X/Y copolymer, and Y is a softening comonomer selected from the group consisting of alkyl acrylate and alkyl methacrylate, such as methyl acrylate or methyl methacrylate, and wherein the alkyl groups have from 1-8 carbon atoms, Y is in the range of 0 to about 50 weight % of the E/X/Y copolymer, and wherein the acid groups present in said ionomeric polymer are partially neutralized with a metal selected from the group consisting of zinc, sodium, lithium, calcium, magnesium, and combinations thereof.

E/X/Y, where E is ethylene, X is a softening comonomer such as present in an amount of from 0 wt. % to about 50 wt. % of the polymer, and Y is present in an amount from about 5 wt. % to about 35 wt. % of the polymer, and wherein the acid moiety is neutralized from about 1% to about 90% to form an ionomer with a cation such as lithium, sodium, potassium, magnesium, calcium, barium, lead, tin, zinc or aluminum, or a combination of such cations.

The ionomer may also be a so-called bimodal ionomer as described in U.S. Pat. No. 6,562,906 (the entire contents of which are herein incorporated by reference). These ionomers are bimodal as they are prepared from blends comprising polymers of different molecular weights. Specifically they include bimodal polymer blend compositions comprising:
a) a high molecular weight component having a weight average molecular weight, Mw, of about 80,000 to about 500,000 and comprising one or more ethylene/α, β-ethylenically unsaturated C₃₋₈ carboxylic acid copolymers and/or one or more ethylene, alkyl(meth)acrylate, (meth)acrylic acid terpolymers; said high molecular weight component being partially neutralized with metal ions selected from the group consisting of lithium, sodium, zinc, calcium, magnesium, and a mixture of any these; and
b) a low molecular weight component having a weight average molecular weight, Mw, of about from about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers; said low molecular weight component being partially neutralized with metal ions selected from the group consisting of lithium, sodium, zinc, calcium, magnesium, and a mixture of any these.

In addition to the unimodal and bimodal ionomers, also included are the so-called “modified ionomers” examples of which are described in U.S. Pat. Nos. 6,100,321, 6,329,458 and 6,616,552 and U.S. Patent Publication US 2003/0158312 A1, the entire contents of all of which are herein incorporated by reference.

The modified unimodal ionomers may be prepared by mixing:
a) an ionomeric polymer comprising ethylene, from 5 to 25 weight percent (meth)acrylic acid, and from 0 to 40 weight percent of a (meth)acrylate monomer, said ionomeric polymer neutralized with metal ions selected from the group consisting of lithium, sodium, zinc, calcium, magnesium, and a mixture of any of these; and
b) from about 5 to about 40 weight percent (based on the total weight of said modified ionomeric polymer) of one or more fatty acids or metal salts of said fatty acid, the metal selected from the group consisting of calcium, sodium, zinc, potassium, and lithium, barium and magnesium and the fatty acid preferably being stearic acid.

The modified bimodal ionomers, which are ionomers derived from the earlier described bimodal ethylene/carboxylic acid polymers (as described in U.S. Pat. No. 6,562,906, the entire contents of which are herein incorporated by reference), are prepared by mixing;
a) a high molecular weight component having a weight average molecular weight, Mw, of about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers; said high molecular weight component being partially neutralized with metal ions selected from the group consisting of lithium, sodium, zinc, calcium, potassium, magnesium, and a mixture of any of these; and
b) a low molecular weight component having a weight average molecular weight, Mw, of about from about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers; said low molecular weight component being partially neutralized with metal ions selected from the group consisting of lithium, sodium, zinc, calcium, potassium, magnesium, and a mixture of any of these; and
c) from about 5 to about 40 weight percent (based on the total weight of said modified ionomeric polymer) of one or more fatty acids or metal salts of said fatty acid, the metal selected from the group consisting of calcium, sodium, zinc, potassium and lithium, barium and magnesium and the fatty acid preferably being stearic acid.

The fatty or waxy acid salts utilized in the various modified ionomers are composed of a chain of alkyl groups containing from about 4 to 75 carbon atoms (usually even numbered) and characterized by a —COOH terminal group. The generic formula for all fatty and waxy acids above acetic acid is CH₃ (CH₂)_{X}COOH, wherein the carbon atom count includes the carboxyl group. The fatty or waxy acids utilized to produce the fatty or waxy acid salts modifiers may be saturated or unsaturated, and they may be present in solid, semi-solid or liquid form.

Examples of suitable saturated fatty acids, i.e., fatty acids in which the carbon atoms of the alkyl chain are connected by single bonds, include but are not limited to stearic acid (C₁₈, i.e., CH₃(CH₂)₁₆COOH), palmitic acid (C₁₆, i.e., CH₃(CH₂)₁₄COOH), pelargonic acid (C₉, i.e., CH₃(CH₂)₇COOH) and lauric acid (C₁₂, i.e., CH₃(CH₂)₁₀OCOOH). Examples of suitable unsaturated fatty acids, i.e., a fatty acid in which there are one or more double bonds between the carbon atoms in the alkyl chain, include but are not limited to oleic acid (C₁₃, i.e., CH₃(CH₂)₇CH:CH(CH₂)₇COOH).

The source of the metal ions used to produce the metal salts of the fatty or waxy acid salts used in the various modified ionomers are generally various metal salts which provide the metal ions capable of neutralizing, to various extents, the carboxylic acid groups of the fatty acids. These include the sulfate, carbonate, acetate and hydroxylate salts of zinc, barium, calcium and magnesium.

Since the fatty acid salts modifiers comprise various combinations of fatty acids neutralized with a large number of different metal ions, several different types of fatty acid salts may be utilized in the invention, including metal stearates, laureates, oleates, and palmitates, with calcium, zinc, sodium, lithium, potassium and magnesium stearate being preferred, and calcium and sodium stearate being most preferred.

The fatty or waxy acid or metal salt of said fatty or waxy acid is present in the modified ionomeric polymers in an amount of from about 5 to about 40, preferably from about 7 to about 35, more preferably from about 8 to about 20 weight percent (based on the total weight of said modified ionomeric polymer).

As a result of the addition of the one or more metal salts of a fatty or waxy acid, from about 40 to 100, preferably from about 50 to 100, more preferably from about 70 to 100 percent of the acidic groups in the final modified ionomeric polymer composition are neutralized by a metal ion.

An example of such a modified ionomer polymer is DuPont® HPF-1000 available from E.I DuPont de Nemours and Co. Inc.

Another preferred material which may be used as a component of the core, cover layer and/or intermediate layer of the golf balls of the present disclosure are the polyalkenamers which may be prepared by ring opening metathesis polymerization of one or more cycloalkenes in the presence of organometallic catalysts as described in U.S. Pat. Nos. 3,492,245, and 3,804,803, the entire contents of both of which are herein incorporated by reference. Examples of suitable polyalkenamer rubbers are polybutenamer rubber, polypentenamer rubber, polyhexenamer rubber, polyheptenamer rubber, polyoctenamer rubber, polynonenamer rubber, polydecenamer rubber polyundecenamer rubber, polydodecenamer rubber, polytridecenamer rubber. For further details concerning polyalkenamer rubber, see Rubber Chem. & Tech., Vol. 47, page 511-596, 1974, which is incorporated herein by reference.

The polyalkenamer rubber preferably contains from about 50 to about 99, preferably from about 60 to about 99, more preferably from about 65 to about 99, even more preferably from about 70 to about 90 percent of its double bonds in the trans-configuration. The preferred form of the polyalkenamer has a trans content of approximately 80%, however, compounds having other ratios of the cis- and trans-isomeric forms of the polyalkenamer can also be obtained by blending available products for use in making the composition.

The polyalkenamer rubber has a molecular weight (as measured by GPC) from about 10,000 to about 300,000, preferably from about 20,000 to about 250,000, more preferably from about 30,000 to about 200,000, even more preferably from about 50,000 to about 150,000.

The polyalkenamer rubber has a degree of crystallization (as measured by DSC secondary fusion) from about 5 to about 70, preferably from about 6 to about 50, more preferably from about from 6.5 to about 50%, even more preferably from about from 7 to about 45%.

A most preferable polyalkenamer rubber for use in the golf balls of the present invention is a polyoctenamer. Polyoctenamer rubbers are commercially available from Huls AG of Marl, Germany, and through its distributor in the U.S., Creanova Inc. of Somerset, N.J., and sold under the trademark VESTENAMER®. Two grades of the VESTENAMER® trans-polyoctenamer are commercially available: VESTENAMER 8012 designates a material having a trans-content of approximately 80% (and a cis-content of 20%) with a melting point of approximately 54° C.; and VESTENAMER 6213 designates a material having a trans-content of approximately 60% (cis-content of 40%) with a melting point of approximately 30° C. Both of these polymers have a double bond at every eighth carbon atom in the ring.

The polyalkenamer rubbers may also be blended within other polymers and an especially preferred blend is that of a polyalkenamer and a polyamide. A more complete description of the polyalkenamer rubbers are disclosed in U.S. Pat. No. 7,528,196 and copending U.S. application Ser. No. 12/415,522, filed on Mar. 31, 2009, both in the name of Hyun Kim et al., the entire contents of both of which are hereby incorporated by reference.

Another preferred material which may be used as a component of the core, cover layer or intermediate layer of the golf balls of the present disclosure is a blend of a homopolyamide or copolyamide which is itself modified with a functional polymer modifier. Illustrative polyamides for use in the polyamide compositions include those obtained by: (1) polycondensation of (a) a dicarboxylic acid, such as oxalic acid, adipic acid, sebacic acid, terephthalic acid, isophthalic acid, or 1,4-cyclohexanedicarboxylic acid, with (b) a diamine, such as ethylenediamine, tetramethylenediamine, pentamethylenediamine, hexamethylenediamine, decamethylenediamine, 1,4-cyclohexyldiamine or m-xylylenediamine; (2) a ring-opening polymerization of cyclic lactam, such as ε-caprolactam or ω-laurolactam; (3) polycondensation of an aminocarboxylic acid, such as 6-aminocaproic acid, 9-aminononanoic acid, 11-aminoundecanoic acid or 12-aminododecanoic acid; (4) copolymerization of a cyclic lactam with a dicarboxylic acid and a diamine; or any combination of (1)-(4). In certain examples, the dicarboxylic acid may be an aromatic dicarboxylic acid or a cycloaliphatic dicarboxylic acid. In certain examples, the diamine may be an aromatic diamine or a cycloaliphatic diamine. Specific examples of suitable polyamides include polyamide 6; polyamide 11; polyamide 12; polyamide 4,6; polyamide 6,6; polyamide 6,9; polyamide 6,10; polyamide 6,12; polyamide MXD6; PA12,CX; PA12, IT; PPA; PA6, IT; and PA6/PPE.

The functional polymer modifier of the polyamide used in the ball covers or intermediate layers of the present disclosure can include copolymers or terpolymers having a glycidyl group, hydroxyl group, maleic anhydride group or carboxylic group, collectively referred to as functionalized polymers. These copolymers and terpolymers may comprise an α-olefin. Examples of suitable α-olefins include ethylene, propylene, 1-butene, 1-pentene, 3-methyl-1-butene, 1-hexene, 4-methyl-1-petene, 3-methyl-1-pentene, 1-octene, 1-decene-, 1-dodecene, 1-tetradecene, 1-hexadecene, 1-octadecene, 1-eicocene, 1-dococene, 1-tetracocene, 1-hexacocene, 1-octacocene, and 1-triacontene. One or more of these α-olefins may be used.

Examples of suitable glycidyl groups in copolymers or terpolymers in the polymeric modifier include esters and ethers of aliphatic glycidyl, such as allylglycidylether, vinylglycidylether, glycidyl maleate and itaconatem glycidyl acrylate and methacrylate, and also alicyclic glycidyl esters and ethers, such as 2-cyclohexene-1-glycidylether, cyclohexene-4,5 diglyxidylcarboxylate, cyclohexene-4-glycidyl carobxylate, 5-norboenene-2-methyl-2-glycidyl carboxylate, and endocis-bicyclo(2,2,1)-5-heptene-2,3-diglycidyl dicarboxylate. These polymers having a glycidyl group may comprise other monomers, such as esters of unsaturated carboxylic acid, for example, alkyl(meth)acrylates or vinyl esters of unsaturated carboxylic acids. Polymers having a glycidyl group can be obtained by copolymerization or graft polymerization with homopolymers or copolymers.

Examples of suitable terpolymers having a glycidyl group include LOTADER AX8900 and AX8920, marketed by Atofina Chemicals, ELVALOY marketed by E.I. Du Pont de Nemours & Co., and REXPEARL marketed by Nippon Petrochemicals Co., Ltd. Additional examples of copolymers comprising epoxy monomers and which are suitable for use within the scope of the present invention include styrene-butadiene-styrene block copolymers in which the polybutadiene block contains epoxy group, and styrene-isoprene-styrene block copolymers in which the polyisoprene block contains epoxy. Commercially available examples of these epoxy functional copolymers include ESBS A1005, ESBS A1010, ESBS A1020, ESBS AT018, and ESBS AT019, marketed by Daicel Chemical Industries, Ltd.

Examples of polymers or terpolymers incorporating a maleic anhydride group suitable for use within the scope of the present invention include maleic anhydride-modified ethylene-propylene copolymers, maleic anhydride-modified ethylene-propylene-diene terpolymers, maleic anhydride-modified polyethylenes, maleic anhydride-modified polypropylenes, ethylene-ethylacrylate-maleic anhydride terpolymers, and maleic anhydride-indene-styrene-cumarone polymers. Examples of commercially available copolymers incorporating maleic anhydride include: BONDINE, marketed by Sumitomo Chemical Co., such as BONDINE AX8390, an ethylene-ethyl acrylate-maleic anhydride terpolymer having a combined ethylene acrylate and maleic anhydride content of 32% by weight, and BONDINE TX TX8030, an ethylene-ethyl acrylate-maleic anhydride terpolymer having a combined ethylene acrylate and maleic anhydride content of 15% by weight and a maleic anhydride content of 1% to 4% by weight; maleic anhydride-containing LOTADER 3200, 3210, 6200, 8200, 3300, 3400, 3410, 7500, 5500, 4720, and 4700, marketed by Atofina Chemicals; EXXELOR VAI 803, a maleic anyhydride-modified ethylene-propylene copolymer having a maleic any hydride content of 0.7% by weight, marketed by Exxon Chemical Co.; and KRATON FG 1901X, a maleic anhydride functionalized triblock copolymer having polystyrene endblocks and poly(ethylene/butylene) midblocks, marketed by Shell Chemical. Preferably the functional polymer component is a maleic anhydride grafted polymers preferably maleic anhydride grafted polyolefins (for example, Exxellor VA1803).

The cores of the golf balls of the present disclosure may include the traditional rubber components used in golf ball applications including, both natural and synthetic rubbers, such as cis-1,4-polybutadiene, trans-1,4-polybutadiene, 1,2-polybutadiene, cis-polyisoprene, trans-polyisoprene, polychloroprene, polybutylene, styrene-butadiene rubber, styrene-butadiene-styrene block copolymer and partially and fully hydrogenated equivalents, styrene-isoprene-styrene block copolymer and partially and fully hydrogenated equivalents, nitrile rubber, silicone rubber, and polyurethane, as well as mixtures of these. Polybutadiene rubbers, especially 1,4-polybutadiene rubbers containing at least 40 mol %, and more preferably 80 to 100 mol % of cis-1,4 bonds, are preferred because of their high rebound resilience, moldability, and high strength after vulcanization. The polybutadiene component may be synthesized by using rare earth-based catalysts, nickel-based catalysts, or cobalt-based catalysts, conventionally used in this field. Polybutadiene obtained by using lanthanum rare earth-based catalysts usually employ a combination of a lanthanum rare earth (atomic number of 57 to 71)-compound, but particularly preferred is a neodymium compound.

The 1,4-polybutadiene rubbers have a molecular weight distribution (Mw/Mn) of from about 1.2 to about 4.0, preferably from about 1.7 to about 3.7, even more preferably from about 2.0 to about 3.5, most preferably from about 2.2 to about 3.2. The polybutadiene rubbers have a Mooney viscosity (ML₁₊₄(100° C.)) of from about 20 to about 80, preferably from about 30 to about 70, even more preferably from about 30 to about 60, most preferably from about 35 to about 50. The term “Mooney viscosity” used herein refers in each case to an industrial index of viscosity as measured with a Mooney viscometer, which is a type of rotary plastometer (see JIS K6300). This value is represented by the symbol ML₁₊₄(100° C.), wherein “M” stands for Mooney viscosity, “L” stands for large rotor (L-type), “1+4” stands for a pre-heating time of 1 minute and a rotor rotation time of 4 minutes, and “100° C.” indicates that measurement was carried out at a temperature of 100° C. As readily appreciated by one skilled in the art, blends of polybutadiene rubbers may also be utilized in the golf balls of the present invention, such blends may be prepared with any mixture of rare earth-based catalysts, nickel-based catalysts, or cobalt-based catalysts derived materials, and from materials having different molecular weights, molecular weight distributions and Mooney viscosity.

The cores of the golf balls of the present disclosure may also include 1,2-polybutadienes having differing tacticity, all of which are suitable as unsaturated polymers for use in the presently disclosed compositions, are atactic 1,2-polybutadiene, isotactic 1,2-polybutadiene, and syndiotactic 1,2-polybutadiene. Syndiotactic 1,2-polybutadiene having crystallinity suitable for use as an unsaturated polymer in the presently disclosed compositions are polymerized from a 1,2-addition of butadiene. The presently disclosed golf balls may include syndiotactic 1,2-polybutadiene having crystallinity and greater than about 70% of 1,2-bonds, more preferably greater than about 80% of 1,2-bonds, and most preferably greater than about 90% of 1,2-bonds. Also, the 1,2-polybutadiene may have a mean molecular weight between about 10,000 and about 350,000, more preferably between about 50,000 and about 300,000, more preferably between about 80,000 and about 200,000, and most preferably between about 10,000 and about 150,000. Examples of suitable syndiotactic 1,2-polybutadienes having crystallinity suitable for use in golf balls are sold under the trade names RB810, RB820, and RB830 by JSR Corporation of Tokyo, Japan.

When synthetic rubbers such as the aforementioned polybutadienes or polyalkenamers and their blends are used in the golf balls they may contain further materials typically often used in rubber formulations including crosslinking agents, co-crosslinking agents, peptizers and accelerators.

Suitable cross-linking agents for use in the golf balls of the present invention include peroxides, sulfur compounds, or other known chemical cross-linking agents, as well as mixtures of these. Non-limiting examples of suitable cross-linking agents include primary, secondary, or tertiary aliphatic or aromatic organic peroxides. Peroxides containing more than one peroxy group can be used, such as 2,5-dimethyl-2,5-di(tert-butylperoxy)hexane and 1,4-di-(2-tert-butyl peroxyisopropyl)benzene. Both symmetrical and asymmetrical peroxides can be used, for example, tert-butyl perbenzoate and tert-butyl cumyl peroxide. Peroxides incorporating carboxyl groups also are suitable. The decomposition of peroxides used as cross-linking agents in the present invention can be brought about by applying thermal energy, shear, irradiation, reaction with other chemicals, or any combination of these. Both homolytically and heterolytically decomposed peroxide can be used in the present invention. Non-limiting examples of suitable peroxides include: diacetyl peroxide; di-tert-butyl peroxide; dibenzoyl peroxide; dicumyl peroxide; 2,5-dimethyl-2,5-di(benzoylperoxy)hexane; 1,4-bis-(t-butylperoxyisopropyl)benzene; t-butylperoxybenzoate; 2,5-dimethyl-2,5-di-(t-butylperoxy)hexyne-3, such as Trigonox 145-45B, marketed by Akrochem Corp. of Akron, Ohio; 1,1-bis(t-butylperoxy)-3,3,5 tri-methylcyclohexane, such as Varox 231-XL, marketed by R.T. Vanderbilt Co., Inc. of Norwalk, Conn.; and di-(2,4-dichlorobenzoyl)peroxide. The cross-linking agents can be blended in total amounts of about 0.05 parts to about 5 parts, more preferably about 0.2 part to about 3 parts, and most preferably about 0.2 part to about 2 parts, by weight of the cross-linking agents per 100 parts by weight of the unsaturated polymer.

Each cross-linking agent has a characteristic decomposition temperature at which 50% of the cross-linking agent has decomposed when subjected to that temperature for a specified time period (t_{1/2}), For example, 1,1-bis-(t-butylperoxy)-3,3,5-tri-methylcyclohexane at t_{1/2}=0.1 hr has a decomposition temperature of 138° C. and 2,5-dimethyl-2,5-di-(t-butylperoxy)hexyne-3 at t_{1/2}=0.1 hr has a decomposition temperature of 182° C. Two or more cross-linking agents having different characteristic decomposition temperatures at the same t_{1/2} may be blended in the composition. For example, where at least one cross-linking agent has a first characteristic decomposition temperature less than 150° C., and at least one cross-linking agent has a second characteristic decomposition temperature greater than 150° C., the composition weight ratio of the at least one cross-linking agent having the first characteristic decomposition temperature to the at least one cross-linking agent having the second characteristic decomposition temperature can range from 5:95 to 95:5, or more preferably from 10:90 to 50:50.

Besides the use of chemical cross-linking agents, exposure of the composition to radiation also can serve as a cross-linking agent. Radiation can be applied to the unsaturated polymer mixture by any known method, including using microwave or gamma radiation, or an electron beam device. Additives may also be used to improve radiation curing of the diene polymer.

The rubber and cross-linking agent may be blended with a co-cross-linking agent, which may be a metal salt of an unsaturated carboxylic acid. Examples of these include zinc and magnesium salts of unsaturated fatty acids having 3 to 8 carbon atoms, such as acrylic acid, methacrylic acid, maleic acid, and fumaric acid, palmitic acid with the zinc salts of acrylic and methacrylic acid being most preferred. The unsaturated carboxylic acid metal salt can be blended in a rubber either as a preformed metal salt, or by introducing an α,β-unsaturated carboxylic acid and a metal oxide or hydroxide into the rubber composition, and allowing them to react in the rubber composition to form a metal salt. The unsaturated carboxylic acid metal salt can be blended in any desired amount, but preferably in amounts of about 10 parts to about 60 parts by weight of the unsaturated carboxylic acid per 100 parts by weight of the synthetic rubber.

The core compositions used in the present invention may also incorporate one or more of the so-called “peptizers”. The peptizer preferably comprises an organic sulfur compound and/or its metal or non-metal salt. Examples of such organic sulfur compounds include thiophenols, such as pentachlorothiophenol, 4-butyl-o-thiocresol, 4 t-butyl-p-thiocresol, and 2-benzamidothiophenol; thiocarboxylic acids, such as thiobenzoic acid; 4,4′ dithio dimorpholine; and, sulfides, such as dixylyl disulfide, dibenzoyl disulfide; dibenzothiazyl disulfide; di(pentachlorophenyl)disulfide; dibenzamido diphenyldisulfide (DBDD), and alkylated phenol sulfides, such as VULTAC marketed by Atofina Chemicals, Inc. of Philadelphia, Pa. Preferred organic sulfur compounds include pentachlorothiophenol, and dibenzamido diphenyldisulfide.

Examples of the metal salt of an organic sulfur compound include sodium, potassium, lithium, magnesium calcium, barium, cesium and zinc salts of the above-mentioned thiophenols and thiocarboxylic acids, with the zinc salt of pentachlorothiophenol being most preferred.

Examples of the non-metal salt of an organic sulfur compound include ammonium salts of the above-mentioned thiophenols and thiocarboxylic acids wherein the ammonium cation has the general formula [NR¹R²R³R⁴]⁺ where R¹, R², R³ and R⁴ are selected from the group consisting of hydrogen, a C₁-C₂₀ aliphatic, cycloaliphatic or aromatic moiety, and any and all combinations thereof, with the most preferred being the NH₄⁺-salt of pentachlorothiophenol.

Additional peptizers include aromatic or conjugated peptizers comprising one or more heteroatoms, such as nitrogen, oxygen and/or sulfur. More typically, such peptizers are heteroaryl or heterocyclic compounds having at least one heteroatom, and potentially plural heteroatoms, where the plural heteroatoms may be the same or different. Such peptizers include peptizers such as an indole peptizer, a quinoline peptizer, an isoquinoline peptizer, a pyridine peptizer, purine peptizer, a pyrimidine peptizer, a diazine peptizer, a pyrazine peptizer, a triazine peptizer, a carbazole peptizer, or combinations of such peptizers.

Suitable peptizers also may include one or more additional functional groups, such as halogens, particularly chlorine; a sulfur-containing moiety exemplified by thiols, where the functional group is sulfhydryl (—SH), thioethers, where the functional group is —SR, disulfides, (R₁S—SR₂), etc.; and combinations of functional groups. Such peptizers are more fully disclosed in copending U.S. Application No. 60/752,475 filed on Dec. 20, 2005 in the name of Hyun Kim et al, the entire contents of which are herein incorporated by reference. A most preferred example is 2,3,5,6-tetrachloro-4-pyridinethiol (TCPT).

The peptizer, if employed in the golf balls of the present invention, is present in an amount up to about 10, from about 0.01 to about 10, preferably of from about 0.10 to about 7, more preferably of from about 0.15 to about 5 parts by weight per 100 parts by weight of the synthetic rubber component.

The core compositions can also comprise one or more accelerators of one or more classes. Accelerators are added to an unsaturated polymer to increase the vulcanization rate and/or decrease the vulcanization temperature. Accelerators can be of any class known for rubber processing including mercapto-, sulfenamide-, thiuram, dithiocarbamate, dithiocarbamyl-sulfenamide, xanthate, guanidine, amine, thiourea, and dithiophosphate accelerators. Specific commercial accelerators include 2-mercaptobenzothiazole and its metal or non-metal salts, such as Vulkacit Mercapto C, Mercapto MGC, Mercapto ZM-5, and ZM marketed by Bayer AG of Leverkusen, Germany, Nocceler M, Nocceler MZ, and Nocceler M-60 marketed by Ouchisinko Chemical Industrial Company, Ltd. of Tokyo, Japan, and MBT and ZMBT marketed by Akrochem Corporation of Akron, Ohio. A more complete list of commercially available accelerators is given in The Vanderbilt Rubber Handbook: 13^{th} Edition (1990, R.T. Vanderbilt Co.), pp. 296-330, in Encyclopedia of Polymer Science and Technology, Vol. 12 (1970, John Wiley & Sons), pp. 258-259, and in Rubber Technology Handbook (1980, Hanser/Gardner Publications), pp. 234-236. Preferred accelerators include 2-mercaptobenzothiazole (MBT) and its salts. The synthetic rubber composition can further incorporate from about 0.1 part to about 10 parts by weight of the accelerator per 100 parts by weight of the rubber. More preferably, the ball composition can further incorporate from about 0.2 part to about 5 parts, and most preferably from about 0.5 part to about 1.5 parts, by weight of the accelerator per 100 parts by weight of the rubber.

### Fillers

The various polymeric compositions used to prepare the golf balls of the present invention also can incorporate one or more fillers. Such fillers are typically in a finely divided form, for example, in a size generally less than about 20 mesh, preferably less than about 100 mesh U.S. standard size, except for fibers and flock, which are generally elongated. Filler particle size will depend upon desired effect, cost, ease of addition, and dusting considerations. The appropriate amounts of filler required will vary depending on the application but typically can be readily determined without undue experimentation.

The filler preferably is selected from the group consisting of precipitated hydrated silica, limestone, clay, talc, asbestos, barytes, glass fibers, aramid fibers, mica, calcium metasilicate, barium sulfate, zinc sulfide, lithopone, silicates, silicon carbide, diatomaceous earth, carbonates such as calcium or magnesium or barium carbonate, sulfates such as calcium or magnesium or barium sulfate, metals, including tungsten, steel, copper, cobalt or iron, metal alloys, tungsten carbide, metal oxides, metal stearates, and other particulate carbonaceous materials, and any and all combinations thereof. Preferred examples of fillers include metal oxides, such as zinc oxide and magnesium oxide. In another preferred aspect the filler comprises a continuous or non-continuous fiber. In another preferred aspect the filler comprises one or more so called nanofillers, as described in U.S. Pat. No. 6,794,447 and copending U.S. patent application Ser. No. 10/670,090 filed on Sep. 24, 2003 and copending U.S. patent application Ser. No. 10/926,509 filed on Aug. 25, 2004, the entire contents of each of which are incorporated herein by reference.

Inorganic nanofiller material generally is made of clay, such as hydrotalcite, phyllosilicate, saponite, hectorite, beidellite, stevensite, vermiculite, halloysite, mica, montmorillonite, micafluoride, or octosilicate. To facilitate incorporation of the nanofiller material into a polymer material, either in preparing nanocomposite materials or in preparing polymer-based golf ball compositions, the clay particles generally are coated or treated by a suitable compatibilizing agent. The compatibilizing agent allows for superior linkage between the inorganic and organic material, and it also can account for the hydrophilic nature of the inorganic nanofiller material and the possibly hydrophobic nature of the polymer. Compatibilizing agents may exhibit a variety of different structures depending upon the nature of both the inorganic nanofiller material and the target matrix polymer. Non-limiting examples include hydroxy-, thiol-, amino-, epoxy-, carboxylic acid-, ester-, amide-, and siloxy-group containing compounds, oligomers or polymers. The nanofiller materials can be incorporated into the polymer either by dispersion into the particular monomer or oligomer prior to polymerization, or by melt compounding of the particles into the matrix polymer. Examples of commercial nanofillers are various Cloisite grades including 10A, 15A, 20A, 25A, 30B, and NA+ of Southern Clay Products (Gonzales, Tex.) and the Nanomer grades including 1.24TL and C.30EVA of Nanocor, Inc. (Arlington Heights, Ill.).

Nanofillers when added into a matrix polymer, such as the polyalkenamer rubber, can be mixed in three ways. In one type of mixing there is dispersion of the aggregate structures within the matrix polymer, but on mixing no interaction of the matrix polymer with the aggregate platelet structure occurs, and thus the stacked platelet structure is essentially maintained. As used herein, this type of mixing is defined as “undispersed”.

However, if the nanofiller material is selected correctly, the matrix polymer chains can penetrate into the aggregates and separate the platelets, and thus when viewed by transmission electron microscopy or x-ray diffraction, the aggregates of platelets are expanded. At this point the nanofiller is said to be substantially evenly dispersed within and reacted into the structure of the matrix polymer. This level of expansion can occur to differing degrees. If small amounts of the matrix polymer are layered between the individual platelets then, as used herein, this type of mixing is known as “intercalation”.

In some circumstances, further penetration of the matrix polymer chains into the aggregate structure separates the platelets, and leads to a complete disruption of the platelet's stacked structure in the aggregate. Thus, when viewed by transmission electron microscopy (TEM), the individual platelets are thoroughly mixed throughout the matrix polymer. As used herein, this type of mixing is known as “exfoliated”. An exfoliated nanofiller has the platelets fully dispersed throughout the polymer matrix; the platelets may be dispersed unevenly but preferably are dispersed evenly.

While not wishing to be limited to any theory, one possible explanation of the differing degrees of dispersion of such nanofillers within the matrix polymer structure is the effect of the compatibilizer surface coating on the interaction between the nanofiller platelet structure and the matrix polymer. By careful selection of the nanofiller it is possible to vary the penetration of the matrix polymer into the platelet structure of the nanofiller on mixing. Thus, the degree of interaction and intrusion of the polymer matrix into the nanofiller controls the separation and dispersion of the individual platelets of the nanofiller within the polymer matrix. This interaction of the polymer matrix and the platelet structure of the nanofiller is defined herein as the nanofiller “reacting into the structure of the polymer” and the subsequent dispersion of the platelets within the polymer matrix is defined herein as the nanofiller “being substantially evenly dispersed” within the structure of the polymer matrix.

If no compatibilizer is present on the surface of a filler such as a clay, or if the coating of the clay is attempted after its addition to the polymer matrix, then the penetration of the matrix polymer into the nanofiller is much less efficient, very little separation and no dispersion of the individual clay platelets occurs within the matrix polymer.

Physical properties of the polymer will change with the addition of nanofiller. The physical properties of the polymer are expected to improve even more as the nanofiller is dispersed into the polymer matrix to form a nanocomposite.

Materials incorporating nanofiller materials can provide these property improvements at much lower densities than those incorporating conventional fillers. For example, a nylon-6 nanocomposite material manufactured by RTP Corporation of Wichita, Kans., uses a 3% to 5% clay loading and has a tensile strength of 11,800 psi and a specific gravity of 1.14, while a conventional 30% mineral-filled material has a tensile strength of 8,000 psi and a specific gravity of 1.36. Using nanocomposite materials with lower inorganic materials loadings than conventional fillers provides the same properties, and this allows products comprising nanocomposite fillers to be lighter than those with conventional fillers, while maintaining those same properties.

Nanocomposite materials are materials incorporating up to about 20%, or from about 0.1% to about 20%, preferably from about 0.1% to about 15%, and most preferably from about 0.1% to about 10% of nanofiller reacted into and substantially dispersed through intercalation or exfoliation into the structure of an organic material, such as a polymer, to provide strength, temperature resistance, and other property improvements to the resulting composite. Descriptions of particular nanocomposite materials and their manufacture can be found in U.S. Pat. Nos. 5,962,553 to Ellsworth, 5,385,776 to Maxfield et al., and 4,894,411 to Okada et al. Examples of nanocomposite materials currently marketed include M1030D, manufactured by Unitika Limited, of Osaka, Japan, and 1015C2, manufactured by UBE America of New York, N.Y.

When nanocomposites are blended with other polymer systems, the nanocomposite may be considered a type of nanofiller concentrate. However, a nanofiller concentrate may be more generally a polymer into which nanofiller is mixed; a nanofiller concentrate does not require that the nanofiller has reacted and/or dispersed evenly into the carrier polymer.

The nanofiller material is added in an amount up to about 20 wt %, from about 0.1% to about 20%, preferably from about 0.1% to about 15%, and most preferably from about 0.1% to about 10% by weight (based on the final weight of the polymer matrix material) of nanofiller reacted into and substantially dispersed through intercalation or exfoliation into the structure of the polymer matrix.

If desired, the various polymer compositions used to prepare the golf balls of the present invention can additionally contain other conventional additives such as plasticizers, pigments, antioxidants, U.V. absorbers, optical brighteners, or any other additives generally employed in plastics formulation or the preparation of golf balls.

Another particularly well-suited additive for use in the various polymer compositions used to prepare the golf balls of the present invention includes compounds having the general formula:

(R₂N)ₘ—R′—(X(O)ₙ(OR)_{y})ₘ,

where R is hydrogen, or a C₁-C₂₀ aliphatic, cycloaliphatic or aromatic systems; R′ is a bridging group comprising one or more C₁-C₂₀ straight chain or branched aliphatic or alicyclic groups, or substituted straight chain or branched aliphatic or alicyclic groups, or aromatic group, or an oligomer of up to 12 repeating units including, but not limited to, polypeptides derived from an amino acid sequence of up to 12 amino acids; and X is C or S or P with the proviso that when X=C, n=1 and y=1 and when X=S, n=2 and y=1, and when X=P, n=0 or 1 and y=2 or 4. Also, m=1-3. These materials are more fully described in copending U.S. patent application Ser. No. 11/182,170, filed on Jul. 14, 2005, the entire contents of which are incorporated herein by reference.

Preferably the material is selected from the group consisting of 4,4′-methylene-bis-(cyclohexylamine)carbamate (commercially available from R.T. Vanderbilt Co., Norwalk Conn. under the tradename Diak® 4), 11-aminoundecanoicacid, 12-aminododecanoic acid, epsilon-caprolactam; omega-caprolactam, and any and all combinations thereof.

In an especially preferred aspect, a nanofiller additive component in the golf ball of the present invention is surface modified with a compatibilizing agent comprising the earlier described compounds having the general formula:

(R₂N)ₘ—R′—(X(O)ₙOR_{y})ₘ,

A most preferred aspect would be a filler comprising a nanofiller clay material surface modified with an amino acid including 12-aminododecanoic acid. Such fillers are available from Nanonocor Co. under the tradename Nanomer 1.24TL.

The filler can be blended in variable effective amounts, such as amounts of greater than 0 to at least about 80 parts, and more typically from about 10 parts to about 80 parts, by weight per 100 parts by weight of the base rubber. If desired, the rubber composition can additionally contain effective amounts of a plasticizer, an antioxidant, and any other additives generally used to make golf balls.

The polymer compositions used as a component of the golf balls of the present invention may also be further modified by addition of a monomeric aliphatic and/or aromatic amide as described in copending application Ser. No. 11/592,109 filed on Nov. 1, 2006 in the name of Hyun Kim et al., the entire contents of which are hereby incorporated by reference.

Golf balls within the scope of the present invention also can include, in suitable amounts, one or more additional ingredients generally employed in golf ball compositions. Agents provided to achieve specific functions, such as additives and stabilizers, can be present. Exemplary suitable ingredients include colorants, antioxidants, colorants, dispersants, mold releasing agents, processing aids, fillers, and any and all combinations thereof. Although not required, UV stabilizers, or photo stabilizers such as substituted hydroxphenyl benzotriazoles may be utilized in the present invention to enhance the UV stability of the final compositions. An example of a commercially available UV stabilizer is the stabilizer sold by Ciba Geigy Corporation under the tradename TINUVIN.

### Golf Ball Composition and Construction

In one embodiment the core of the golf balls of the present disclosure, when present, may comprise multiple core layers. The core and any core layers may be made from material commonly used to prepare golf ball cores including, but not limited to, c is 1,4-polybutadiene rubber, syn 1,2-polybutadiene rubber, polyalkenamer rubber, ionomers, thermoplastic and thermoset polyurethanes and polyureas. A preferred material is cis 1,4-polybutadiene. The various core layers (including the central core) may each exhibit a different hardness. The difference between the center hardness and that of the next adjacent layer, as well as the difference in hardness between the various core layers may be greater than 2, preferably greater than 5, most preferably greater than 10 units of Shore D. In one preferred embodiment, the hardness of the center and each sequential layer increases progressively outwards from the center to outer core layer. In another preferred embodiment, the hardness of the center and each sequential layer decreases progressively inwards from the outer core layer to the center.

The core of the golf balls of the present invention, if present, may have a diameter of from about 0.5 to about 1.62, preferably from about 0.7 to about 1.60, more preferably from about 1 to about 1.58, yet more preferably from about 1.15 to about 1.54, and most preferably from about 1.20 to about 1.50 in.

The core of the golf balls of the present invention, if present, also may have a PGA compression of from about 10 to about 200, preferably from about 20 to about 185, more preferably from about 30 to about 180, and most preferably from about 40 to about 120. In another embodiment, the core of the balls may have a PGA compression of from about 20 to about 100, preferably from about 25 to about 90, more preferably from about 30 to about 80.

The golf balls also may have a cover layer. The outer cover layer of the balls may have a thickness of about 0.01 to about 0.10, preferably from about 0.015 to about 0.08, more preferably from about 0.02 to about 0.06 in.

The cover layer the balls may have a hardness Shore D from about 40 to about 70, preferably from about 45 to about 70 or about 50 to about 70, more preferably from 47 to about 68 or about 45 to about 70, and most preferably from about 50 to about 65.

The golf balls also may have at least one intermediate layer. The golf ball of the present invention may comprise from 0 to 5, preferably from 0 to 4, more preferably from 1 to 5, and most preferably from 1 to 4 such intermediate layer(s).

The COR of the golf balls of the present invention may be greater than about 0.760, preferably greater than about 0.780, more preferably greater than 0.790, most preferably greater than 0.795, and especially greater than 0.800 at 125 ft/sec inbound velocity. In another embodiment, the COR of the golf balls may be greater than about 0.760, preferably greater than about 0.780, more preferably greater than 0.790, most preferably greater than 0.795, and especially greater than 0.800 at 143 ft/sec inbound velocity.

The polyurethane ionomer may be used in the core, intermediate layer(s), and/or cover layer of the golf ball. In certain embodiments, the polyurethane ionomer is the majority ingredient of the material used to form at least one structural component (e.g., the core, intermediate layer(s) or cover layer) of the golf ball. As used herein “majority ingredient” means that the polyurethane ionomer is present in an amount of at least about 50 wt %, particularly at least 60 wt %, and more particularly at least 80 wt %, based on the total weight of all the ingredients in the final material used to form at least one structural component.

In particular embodiments, the polyurethane ionomer is included in the cover layer of the golf ball.

In certain embodiments, the golf ball may be a two-piece ball that consists essentially of a core and a cover layer. In other embodiments, the golf ball may be a three-piece ball that consists essentially of a core, an intermediate layer, and a cover layer. In additional embodiments, the golf ball may be a four-piece ball that consists essentially of a core, two intermediate layers, and a cover layer. In further embodiments, the golf ball may be a five-piece golf ball that consists essentially of a core, three intermediate layers, and a cover layer.

For example, in one embodiment, the golf ball comprises:

(a) a core;

(b) an inner mantle layer;

(c) an intermediate mantle layer;

(d) an outer mantle layer; and

(e) at least one cover layer;

wherein the core has a PGA compression of less than 70, and the core/inner mantle layer/intermediate mantle layer combined construct has a PGA compression of at least 30, and wherein the polyurethane ionomer is included in at least one of (a)-(e).

In another embodiment, the golf ball comprises:

(a) a core material having a PGA compression of less than 70 and a material flexural modulus of less than 20 kpsi;

(b) an inner mantle layer material;

(c) an intermediate mantle layer material;

(d) an outer mantle layer material; and

(e) at least one cover layer material;

wherein the material of each of (a), (b), (c) and (d) have a material flexural modulus and the material flexural modulus of each of (a), (b), (c) and (d) increases from the core material to the outer mantle layer material such that each successive layer between the core material and the outer mantle layer material has a flexural modulus that is greater relative to the immediately adjacent inner layer material, and wherein the polyurethane ionomer is included in at least one of (a)-(e).

According to a further embodiment, there is disclosed a five-piece golf ball comprising:

(a) a core material having a flexural modulus of less than 15 kpsi;

(b) an inner mantle layer material adjacent to the core material, wherein the inner mantle layer material has a flexural modulus of 2-35 kpsi;

(c) an intermediate mantle layer material adjacent to the inner mantle layer material, wherein the intermediate mantle layer material has a flexural modulus of 10-50 kpsi;

(d) an outer mantle layer material adjacent to the intermediate mantle layer material, wherein the outer mantle layer material has a flexural modulus of 30-110 kpsi; and

(e) an outer cover layer material,

wherein the polyurethane ionomer is included in at least one of (a)-(e).

Another embodiment is a golf ball comprising:

(a) a core having a PGA compression of less than 40;

(b) an inner mantle layer;

(c) an intermediate mantle layer;

(d) an outer mantle layer; and

(e) an outer cover layer;

wherein the golf ball has sufficient impact durability and a golf ball frequency of <4000 Hz, and wherein the polyurethane ionomer is included in at least one of (a)-(e).

### Method of Making the Golf Balls

The compositions described herein can be formed by any commonly used mixing methods. For instance, the components of a composition can be mixed together with or without melting them. Dry blending equipment, such as a tumble mixer, V-blender, ribbon blender, or two-roll mill, can be used to mix the compositions. The compositions can also be mixed using a mill, internal mixer such as a Banbury or Farrel continuous mixer, extruder or combinations of these, with or without application of thermal energy to produce melting. The various components can be mixed together with the crosslinking agents, or each additive can be added in an appropriate sequence to the milled unsaturated polymer. In another method of manufacture the crosslinking agents and other components can be added to the unsaturated polymer as part of a concentrate using dry blending, roll milling, or melt mixing.

The compositions described herein can also be prepared by using a twin screw extruder with or without pre-mixing prior to charging to the extruder. The barrel temperature for the blending may be between about 140° C. to about 300° C., more preferably between about 160° C. to about 280° C., and most preferably between about 180° C. to about 260° C. The compounded material can be positioned readily around a golf ball core using injection molding. The barrel temperature for the injection molding may be between about 160° C. to about 280° C., more preferably between about 180° C. to about 260° C., and most preferably between about 200° C. and 260° C.

In the case of golf balls having a separate and discrete core (and optionally additional core layers and intermediate layers), they may be prepared by initially positioning a solid preformed core in an injection-molding cavity followed by uniform injection of the intermediate layer and/or cover layer compositions, sequentially over the core, to produce layers of the required thickness and ultimately golf balls of the required diameter. Again use of a heated injection mold allows the temperature to be controlled sufficient to either partially of fully crosslink the material to yield the desired layer properties.

Alternatively, the layers may also be formed around the core or intermediate layer by first forming half shells by injection molding the desired composition, followed by a compression molding the half shells about the core or intermediate layer to effect the curing of the layers in the final ball.

Alternatively, the layers may also be formed around the core or intermediate layer by first forming half shells by injection molding the desired composition, again using a heated injection mold which allows the temperature to be controlled sufficient to either partially of fully crosslink the material to yield the desired half shell properties layer properties. The resulting fully or partially cured half shells may then be compression molded around the core or core plus intermediate layer.

In addition, if radiation is used as a crosslinking agent, then the mixture comprising the unsaturated polymer and other additives can be irradiated following mixing, during forming into a part such as the core, intermediate layer, or outer cover of a ball, or after forming such part.

In addition, the present disclosure also relates to a method of preparation resulting from the combination of injection molding layers and half shells as described above.

Finally, the outer cover and any additional intermediate layers (if any) may also be formed using conventional molding techniques common used in golf ball preparation including but not limited to injection molding, casting and compression molding.

Illustrative embodiments are described below in the following numbered paragraphs.

1. A golf ball comprising a core and at least one layer, wherein at least the core or the layer includes a polyurethane ionomer made by reacting a multi-functional modified ionomer with an isocyanate, wherein the multi-functional modified ionomer is a product of reacting an ionomer with a multi-functional modifier wherein the multi-functional modifier includes at least one carboxyl functional group and at least two additional types of functional groups.

2. The golf ball of paragraph 1, wherein the at least two additional types of functional groups are selected from the group consisting of hydroxyl, isocyanate, acid anhydride, and amino.

3. The golf ball of paragraph 1, wherein the multi-functional modifier includes at least one carboxyl group, at least one amino group, and at least one hydroxyl group.

4. The golf ball of paragraph 1, wherein the multi-functional modifier is an aliphatic carboxylic acid, aliphatic polycarboxylic acid, an aromatic carboxylic acid or an aromatic polycarboxylic acid that is substituted with at least two additional types of functional groups.

5. The golf ball of paragraph 1, wherein the multi-functional modifier is (i) an alkanoic acids of the structure R¹COOH, wherein R¹ is a C₁-C₂₀ alkyl group that is substituted with at least two additional types of functional groups, (ii) a benzoic acid substituted with at least two additional types of functional groups, or (iii) an amino acid substituted with at least one further type of functional group in addition to a carboxyl group and an amino group.

6. The golf ball of paragraph 1, wherein the multi-functional modifier is 4-amino-2-hydroxybenzoic acid; 2-amino-5-hydroxybenzoic acid; 3-amino-4-hydroxybenzoic acid; 4-amino-3-hydroxybenzoic acid; 4-amino-3-hydroxybutyric acid; 4-amino-2-hydroxybutyric acid; a metal or non-metal salt thereof; or a combination thereof.

7. The golf ball of any one of paragraphs 1 to 6, wherein the polyurethane ionomer is partially or fully neutralized with a metal cation or a non-metal cation.

8. The golf ball of any one of paragraphs 1 to 7, wherein the golf ball includes at least one intermediate layer and a cover layer, and the polyurethane ionomer is present in at least one of the intermediate layer or cover layer.

9. The golf ball of any one of paragraphs 1 to 8, wherein the golf ball is a five-piece golf ball.

10. A polyurethane ionomer comprising the reaction product of a multi-functional modified ionomer with an isocyanate, wherein the multi-functional modified ionomer is a product of reacting an ionomer with a multi-functional modifier wherein the multi-functional modifier includes at least one carboxyl functional group and at least two additional types of functional groups.

11. A method for making a golf ball, comprising reacting an ionomer with a multi-functional modifier to produce a multi-functional modified ionomer, wherein the multi-functional modifier includes at least one carboxyl functional group and at least two additional types of functional groups;

reacting the multi-functional modified ionomer with an isocyanate to produce a polyurethane ionomer; and

forming the polyurethane ionomer into a golf ball component.

12. A method comprising reacting an ionomer with a multi-functional modifier to produce a multi-functional modified ionomer, wherein the multi-functional modifier includes at least one carboxyl functional group and at least two additional types of functional groups; and

reacting the multi-functional modified ionomer with an isocyanate to produce a polyurethane ionomer.

In view of the many possible embodiments to which the principles of the disclosed invention may be applied, it should be recognized that the illustrated embodiments are only preferred examples of the invention and should not be taken as limiting the scope of the invention.

What is claimed is:

1. A golf ball comprising a core and at least one layer, wherein at least the core or the layer includes a polyurethane ionomer made by reacting a multi-functional modified ionomer with an isocyanate, wherein the multi-functional modified ionomer is a product of reacting an ionomer with a multi-functional modifier wherein the multi-functional modifier includes at least one carboxyl functional group and at least two additional types of functional groups.

2. The golf ball of claim 1, wherein the at least two additional types of functional groups are selected from the group consisting of hydroxyl, isocyanate, acid anhydride, and amino.

3. The golf ball of claim 1, wherein the multi-functional modifier includes at least one carboxyl group, at least one amino group, and at least one hydroxyl group.

4. The golf ball of claim 1, wherein the multi-functional modifier is an aliphatic carboxylic acid, aliphatic polycarboxylic acid, an aromatic carboxylic acid or an aromatic polycarboxylic acid that is substituted with at least two additional types of functional groups.

5. The golf ball of claim 1, wherein the multi-functional modifier is (i) an alkanoic acids of the structure R¹COOH, wherein R¹ is a C₁-C₂₀ alkyl group that is substituted with at least two additional types of functional groups, (ii) a benzoic acid substituted with at least two additional types of functional groups, or (iii) an amino acid substituted with at least one further type of functional group in addition to a carboxyl group and an amino group.

6. The golf ball of claim 1, wherein the multi-functional modifier is 4-amino-2-hydroxybenzoic acid; 2-amino-5-hydroxybenzoic acid; 3-amino-4-hydroxybenzoic acid; 4-amino-3-hydroxybenzoic acid; 4-amino-3-hydroxybutyric acid; 4-amino-2-hydroxybutyric acid; a metal or non-metal salt thereof; or a combination thereof.

7. The golf ball of claim 1, wherein the polyurethane ionomer is partially or fully neutralized with a metal cation or a non-metal cation.

8. The golf ball of claim 1, wherein the golf ball includes at least one intermediate layer and a cover layer, and the polyurethane ionomer is present in at least one of the intermediate layer or cover layer.

9. A two piece ball consisting essentially of;
I a core; and
II an outer cover layer having a thickness of from about 0.01 to about 0.10 inches and a Shore D hardness as measured on the ball of from about 40 to about 70; and
wherein said outer cover layer comprises a polyurethane ionomer comprising the reaction product of;
a an isocyanate;
b a multi-functional modified ionomer, wherein the multi-functional modified ionomer is a product of reacting
i an ionomer; and
ii a multi-functional modifier wherein the multi-functional modifier includes at least one carboxyl functional group and at least two additional types of functional groups; and
c a basic salt selected form the group consisting of basic metal ion salts, basic non-metal ion salts and combinations thereof.

10. The two piece golf ball of claim 9 wherein said outer cover layer has a thickness of from about 0.015 to about 0.080 inches and a Shore D hardness as measured on the ball of from about 50 to about 70; and
wherein said polyurethane ionomer comprises the reaction product of;
a an socyanate is selected from the group consisting of aliphatic isocyanates, arylaliphatic isocyanates, alicyclic isocyanates, aromatic isocyanates and combinations thereof;
b a multi-functional modified ionomer which is a product of reacting
I an ionomer selected from the group consisting of a unimodal ionomer, a bimodal ionomer, a modified unimodal ionomer, a modified bimodal ionomer and any and all combinations thereof; with
ii a multi-functional modifier wherein the at least two additional types of functional groups are selected from the group consisting of hydroxyl, isocyanate, acid anhydride, and amino and any and all mixtures thereof; and
c a basic salt comprising;
I a basic metal ion salt having a cation selected from the group consisting of Li⁺, Na⁺, K⁺, Zn²⁺, Ca²⁺, Co²⁺, Ni²⁺, Cu²⁺, Pb²⁺, Mg²⁺ and combinations thereof; or
ii a basic non-metal ion salt having an ammonium cation having the general formula [NR¹R²R³R⁴]⁺ where R¹, R², R³ and R⁴ includes one or more of hydrogen, a C₁-C₂₀ aliphatic, cycloaliphatic or aromatic moiety.

11. The two piece golf ball of claim 9 wherein said outer cover layer has a thickness of from about 0.020 inches to about 0.060 inches and a Shore D hardness as measured on the ball of from about 50 to about 65; and comprises said polyurethane ionomer comprising the reaction product of;
a an isocyante is selected from the group consisting of 2,2′-, 2,4′-, and 4,4′-diphenylmethane diisocyanate (MDI); 3,3′-dimethyl-4,4′-biphenylene diisocyanate (TODI); toluene diisocyanate (TDI); para-phenylene diisocyanate (PPDI); meta-phenylene diisocyanate (MPDI); polyphenylene polymethylene polyisocyanate (PMDI) 1,6-hexamethylene diisocyanate (HDI); methylcyclohexylene diisocyanate (HTDI); isophorone diisocyanate (IPDI); meta-tetramethylxylene diisocyanate (m-TMXDI); para-tetramethylxylene diisocyanate (p-TMXDI); and mixtures thereof;
b a multi-functional modified ionomer which is the reaction product of
i a unimodal ionomer of general formula, E/X/Y polymer, wherein E is ethylene, X is acrylic or methacrylic acid, and is present in an amount from about 2 to about 35 weight % of the E/X/Y copolymer, and Y is a softening comonomer selected from the group consisting of methyl acrylate, ethyl acrylate, methyl methacrylate, ethyl methacrylate, and combinations thereof and wherein Y is in the range of 0 to about 50 weight % of the E/X/Y copolymer, and wherein the acid moiety X is neutralized from about 1% to about 90% to form an ionomer with a basic metal salt having a cation such as lithium, sodium, potassium, magnesium, calcium, barium, lead, tin, zinc or aluminum, or a combination; with
ii a multi-functional modifier is selected from the group consisting of, 4-amino-2-hydroxybenzoic acid; 2-amino-5-hydroxybenzoic acid; 3-amino-4-hydroxybenzoic acid; 4-amino-3-hydroxybenzoic acid; 4-amino-3-hydroxybutyric acid; 4-amino-2-hydroxybutyric acid; metal or non-metal salts thereof and combinations thereof; and
c a basic salt comprising;
i a basic metal ion salt is selected from the group consisting of zinc oxide, zinc hydroxide, zinc carbonate, magnesium oxide, magnesium hydroxide, magnesium carbonate, sodium carbonate, potassium carbonate, lihium carbonate and combinations thereof; or
ii a basic non-metal ion salt having the ammonium cation, NH₄⁺.

12. The two piece golf ball of claim 9 wherein said core;
a has a diameter of from about 0.5 to about 1.62 inches;
b has a PGA compression of from about 20 to about 100; and
c comprises a peptizer selected from the group consisting of an organic sulfur compound, a metal salt of an organic sulfur compound, a non-metal salt of an organic sulfur compound, and any and all combinations thereof.

13. A three piece golf ball consisting essentially of
I a core;
II an outer cover layer having a thickness of from about 0.01 to about 0.10 inches and a Shore D hardness as measured on the ball of from about 40 to about 70, and
III an intermediate layer; and
wherein said outer cover layer comprises a polyurethane ionomer comprising the reaction product of;
a an isocyanate;
b a multi-functional modified ionomer, wherein the multi-functional modified ionomer is a product of reacting
i an ionomer; and
ii a multi-functional modifier wherein the multi-functional modifier includes at least one carboxyl functional group and at least two additional types of functional groups; and
c a basic salt selected from the group consisting of basic metal ion salts, basic non-metal ion salts and combinations thereof.

14. The three piece golf ball of claim 13 wherein;
I said outer cover layer has a thickness of from about 0.020 to about 0.080 inches and a Shore D hardness as measured on the ball of from about 38 to about 68, and
II said outer layer has a thickness of from about 0.02 to about 0.200 inches and a Shore D hardness as measured on the ball of greater than about 40; and comprises
wherein said polyurethane ionomer comprises the reaction product of;
a an isocyante is selected from the group consisting of aliphatic isocyanates, arylaliphatic isocyanates, alicyclic isocyanates, aromatic isocyanates and combinations thereof;
b a multi-functional modified ionomer which is a product of reacting
i an ionomer selected from the group consisting of a unimodal ionomer, a bimodal ionomer, a modified unimodal ionomer, a modified bimodal ionomer and any and all combinations thereof; with
ii a multi-functional modifier wherein the at least two additional types of functional groups are selected from the group consisting of hydroxyl, isocyanate, acid anhydride, and amino and any and all mixtures thereof; and
c a basic salt comprising;
i a basic metal ion salt having a cation selected from the group consisting of Li⁺, Na⁺, K⁺, Zn²⁺, Ca²⁺, Co²⁺, Ni²⁺, Cu²⁺, Pb²⁺, Mg²⁺ and combinations thereof; or
ii a basic non-metal ion salt having an ammonium cation having the general formula [NR¹R²R³R⁴]⁺ where R¹, R², R³ and R⁴ includes one or more of hydrogen, a C₁-C₂₀ aliphatic, cycloaliphatic or aromatic moiety.

15. The three piece golf ball of claim 13 wherein;
I said outer cover layer has a thickness of from about 0.025 to about 0.060 inches and a Shore D hardness as measured on the ball of from about 40 to about 65, and comprises and comprises said polyurethane ionomer comprising the reaction product of;
a an isocyante is selected from the group consisting of 2,2′-, 2,4′-, and 4,4′-diphenylmethane diisocyanate (MDI); 3,3′-dimethyl-4,4′-biphenylene diisocyanate (TODI); toluene diisocyanate (TDI); para-phenylene diisocyanate (PPDI); meta-phenylene diisocyanate (MPDI); polyphenylene polymethylene polyisocyanate (PMDI) 1,6-hexamethylene diisocyanate (HDI); methylcyclohexylene diisocyanate (HTDI); isophorone diisocyanate (IPDI); meta-tetramethylxylene diisocyanate (m-TMXDI); para-tetramethylxylene diisocyanate (p-TMXDI); and mixtures thereof;
b a multi-functional modified ionomer which is the reaction product of;
i a unimodal ionomer of general formula, E/X/Y polymer, wherein E is ethylene, X is acrylic or methacrylic acid, and is present in an amount from about 2 to about 35 weight % of the E/X/Y copolymer, and Y is a softening comonomer selected from the group consisting of methyl acrylate, ethyl acrylate, methyl methacrylate, ethyl methacrylate, and combinations thereof and wherein Y is in the range of 0 to about 50 weight % of the E/X/Y copolymer, and wherein the acid moiety X is neutralized from about 1% to about 90% to form an ionomer with a basic metal salt having a cation such as lithium, sodium, potassium, magnesium, calcium, barium, lead, tin, zinc or aluminum, or a combination; with
ii a multi-functional modifier is selected from the group consisting of, 4-amino-2-hydroxybenzoic acid; 2-amino-5-hydroxybenzoic acid; 3-amino-4-hydroxybenzoic acid; 4-amino-3-hydroxybenzoic acid; 4-amino-3-hydroxybutyric acid; 4-amino-2-hydroxybutyric acid; metal or non-metal salts thereof and combinations thereof; and
c a basic salt comprising;
i a basic metal ion salt is selected from the group consisting of zinc oxide, zinc hydroxide, zinc carbonate, magnesium oxide, magnesium hydroxide, magnesium carbonate, sodium carbonate, potassium carbonate, lihium carbonate and combinations thereof; or
ii a basic non-metal ion salt having the ammonium cation, NH₄⁺;
II said intermediate layer has thickness of from about 0.03 to about 0.10 inches and a Shore D hardness as measured on the ball of greater than about 50

16. The three piece golf ball of claim 13 wherein said core;
a has a diameter greater than or equal to 1 inch;
b has a PGA compression of less than about 140; and
c comprises a peptizer selected from the group consisting of an organic sulfur compound, a metal salt of an organic sulfur compound, a non-metal salt of an organic sulfur compound, and any and all combinations thereof.

17. A four piece golf ball consisting essentially of;
I a core;
II an inner intermediate layer;
III an outer intermediate layer; and
IV an outer cover layer having a thickness of from about 0.01 to about 0.10 inches and a Shore D hardness as measured on the ball of from about 40 to about 70, and
wherein said outer cover layer comprises a polyurethane ionomer comprising the reaction product of
a an isocyanate;
b a multi-functional modified ionomer, wherein the multi-functional modified ionomer is a product of reacting
i an ionomer; and
ii a multi-functional modifier wherein the multi-functional modifier includes at least one carboxyl functional group and at least two additional types of functional groups; and
c a basic salt selected form the group consisting of basic metal ion salts, basic non-metal ion salts and combinations thereof.

18. The four piece golf ball of claim 17 wherein
I said inner intermediate layer has a thickness of from about 0.020 to about 0.200 inches and a Shore D hardness as measured on the ball of greater than about 40;
II said outer intermediate layer having a thickness of from about 0.020 to about 0.200 inches and a Shore D hardness as measured on the ball of greater than about 40; and
III said outer cover layer has a thickness of from about 0.020 to about 0.080 inches and a Shore D hardness as measured on the ball of from about 38 to about 68; and
wherein said polyurethane ionomer comprises the reaction product of;
a an isocyante is selected from the group consisting of aliphatic isocyanates, arylaliphatic isocyanates, alicyclic isocyanates, aromatic isocyanates and combinations thereof;
b a multi-functional modified ionomer which is a product of reacting
i an ionomer selected from the group consisting of a unimodal ionomer, a bimodal ionomer, a modified unimodal ionomer, a modified bimodal ionomer and any and all combinations thereof; with
ii a multi-functional modifier wherein the at least two additional types of functional groups are selected from the group consisting of hydroxyl, isocyanate, acid anhydride, and amino and any and all mixtures thereof; and
c a basic salt comprising;
i a basic metal ion salt having a cation selected from the group consisting of Li⁺, Na⁺, K⁺, Zn²⁺, Ca²⁺, Co²⁺, Ni²⁺, Cu²⁺, Pb²⁺, Mg²⁺ and combinations thereof; or
II a basic non-metal ion salt having an ammonium cation having the general formula [NR¹R²R³R⁴]⁺ where R¹, R², R³ and R⁴ includes one or more of hydrogen, a C₁-C₂₀ aliphatic, cycloaliphatic or aromatic moiety.

19. The four piece golf ball of claim 17 wherein
I said inner intermediate layer having a thickness of from about 0.030 to about 0.100 inches and a Shore D hardness as measured on the ball of greater than about 50;
II said outer intermediate layer having a thickness of from about 0.030 to about 0.100 inches and a Shore D hardness as measured on the ball of greater than about 50; and
III said outer cover layer having a thickness of from about 0.025 to about 0.060 inches and a Shore D hardness as measured on the ball of from about 40 to about 65, and
wherein said outer cover layer comprises said polyurethane ionomer comprising the reaction product of
a an isocyante is selected from the group consisting of 2,2′-, 2,4′-, and 4,4′-diphenylmethane diisocyanate (MDI); 3,3′-dimethyl-4,4′-biphenylene diisocyanate (TODI); toluene diisocyanate (TDI); para-phenylene diisocyanate (PPDI); meta-phenylene diisocyanate (MPDI); polyphenylene polymethylene polyisocyanate (PMDI) 1,6-hexamethylene diisocyanate (HDI); methylcyclohexylene diisocyanate (HTDI); isophorone diisocyanate (IPDI); meta-tetramethylxylene diisocyanate (m-TMXDI); para-tetramethylxylene diisocyanate (p-TMXDI); and mixtures thereof;
b a multi-functional modified ionomer which is the reaction product of;
i a unimodal ionomer of general formula, E/X/Y polymer, wherein E is ethylene, X is acrylic or methacrylic acid, and is present in an amount from about 2 to about 35 weight % of the E/X/Y copolymer, and Y is a softening comonomer selected from the group consisting of methyl acrylate, ethyl acrylate, methyl methacrylate, ethyl methacrylate, and combinations thereof and wherein Y is in the range of 0 to about 50 weight % of the E/X/Y copolymer, and wherein the acid moiety X is neutralized from about 1% to about 90% to form an ionomer with a basic metal salt having a cation such as lithium, sodium, potassium, magnesium, calcium, barium, lead, tin, zinc or aluminum, or a combination; with
ii a multi-functional modifier is selected from the group consisting of, 4-amino-2-hydroxybenzoic acid; 2-amino-5-hydroxybenzoic acid; 3-amino-4-hydroxybenzoic acid; 4-amino-3-hydroxybenzoic acid; 4-amino-3-hydroxybutyric acid; 4-amino-2-hydroxybutyric acid; metal or non-metal salts thereof and combinations thereof; and
c a basic salt comprising;
i a basic metal ion salt is selected from the group consisting of zinc oxide, zinc hydroxide, zinc carbonate, magnesium oxide, magnesium hydroxide, magnesium carbonate, sodium carbonate, potassium carbonate, lihium carbonate and combinations thereof; or
ii a basic non-metal ion salt having the ammonium cation, NH₄⁺and wherein
(a) said inner intermediate layer comprises a polyalkenamer having a trans-content of from about 40 to about 95%, a cis-content of from about 5 to about 60%, and a melting point of greater than about 15° C.;
(b) said outer intermediate layer comprises a polymer selected from the group consisting of ionomers, thermoset polyureas, thermoset polyurethanes, thermoplastic polyurethanes, thermoplastic polyureas, polyalkenamers, a multicomponent blend composition (“MCBC”) comprising (A) a block copolymer; and (B) one or more acidic polymers; and (C) one or more basic metal salts present in an amount to neutralize at greater than or equal to about 30 percent of the acid groups of Component (B), and any and all combinations thereof.

20. The four piece golf ball of claim 19 wherein said core;
a has a diameter greater than or equal to 1 inch;
b a PGA compression of less than about 140; and
c comprises a peptizer selected from the group consisting of an organic sulfur compound, a metal salt of an organic sulfur compound, a non-metal salt of an organic sulfur compound, and any and all combinations thereof.

21. A five piece golf ball consisting essentially of;
I a core;
II an inner mantle layer;
III an intermediate mantle layer;
IV an outer mantle layer; and
V an outer cover layer having a thickness of from about 0.01 to about 0.10 inches and a Shore D hardness as measured on the ball of from about 40 to about 70, and
wherein said outer cover layer comprises a polyurethane ionomer comprising the reaction product of;
a an isocyanate;
b a multi-functional modified ionomer, wherein the multi-functional modified ionomer is a product of reacting
i an ionomer; and
ii a multi-functional modifier wherein the multi-functional modifier includes at least one carboxyl functional group and at least two additional types of functional groups; and
c a basic salt selected form the group consisting of basic metal ion salts, basic non-metal ion salts and combinations thereof.

22. The five piece golf ball of claim 21 wherein
I said inner mantle layer comprises a polyalkenamer having a trans-content of from about 40 to about 95%, a cis-content of from about 5 to about 60%, and a melting point of greater than about 15° C.;
II at least one of said intermediate mantle layers or outer mantle layer comprises a polymer selected from the group consisting of ionomers, thermoset polyureas, thermoset polyurethanes, thermoplastic polyurethanes, thermoplastic polyureas, polyalkenamers, a multicomponent blend composition (“MCBC”) comprising (A) a block copolymer; and (B) one or more acidic polymers; and (C) one or more basic metal salts present in an amount to neutralize at greater than or equal to about 30 percent of the acid groups of Component (B), and any and all combinations thereof;
III said outer cover layer has a thickness of from about 0.020 to about 0.080 inches and a Shore D hardness as measured on the ball of from about 38 to about 68, and comprises said polyurethane ionomer which comprises the reaction product of;
a an isocyante is selected from the group consisting of aliphatic isocyanates, arylaliphatic isocyanates, alicyclic isocyanates, aromatic isocyanates and combinations thereof;
b a multi-functional modified ionomer which is a product of reacting
i an ionomer selected from the group consisting of a unimodal ionomer, a bimodal ionomer, a modified unimodal ionomer, a modified bimodal ionomer and any and all combinations thereof; with
ii a multi-functional modifier wherein the at least two additional types of functional groups are selected from the group consisting of hydroxyl, isocyanate, acid anhydride, and amino and any and all mixtures thereof; and
c a basic salt comprising;
i a basic metal ion salt having a cation selected from the group consisting of Li⁺, Na⁺, K⁺, Zn²⁺, Ca²⁺, Co²⁺, Ni²⁺, Cu²⁺, Pb²⁺, Mg²⁺ and combinations thereof; or
ii a basic non-metal ion salt having an ammonium cation having the general formula [NR¹R²R³R⁴]⁺ where R¹, R², R³ and R⁴ includes one or more of hydrogen, a C₁-C₂₀ aliphatic, cycloaliphatic or aromatic moiety.

23. The five piece golf ball of claim 21 wherein
I said inner mantle layer; has a flexural modulus of from about 2 to about 35 kpsi;
II said intermediate mantle layer has a flexural modulus of from about 10 to about 50 kpsi;
III said outer mantle layer has a flexural modulus of from about 30 to about 110 kpsi; and
IV said outer cover layer has a thickness of from about 0.025 to about 0.060 inches and a Shore D hardness as measured on the ball of from about 40 to about 65, and comprises said polyurethane ionomer comprising the reaction product of;
a an isocyante is selected from the group consisting of 2,2′-, 2,4′-, and 4,4′-diphenylmethane diisocyanate (MDI); 3,3′-dimethyl-4,4′-biphenylene diisocyanate (TODI); toluene diisocyanate (TDI); para-phenylene diisocyanate (PPDI); meta-phenylene diisocyanate (MPDI); polyphenylene polymethylene polyisocyanate (PMDI) 1,6-hexamethylene diisocyanate (HDI); methylcyclohexylene diisocyanate (HTDI); isophorone diisocyanate (IPDI); meta-tetramethylxylene diisocyanate (m-TMXDI); para-tetramethylxylene diisocyanate (p-TMXDI); and mixtures thereof;
b a multi-functional modified ionomer which is the reaction product of;
i a unimodal ionomer of general formula, E/X/Y polymer, wherein E is ethylene, X is acrylic or methacrylic acid, and is present in an amount from about 2 to about 35 weight % of the E/X/Y copolymer, and Y is a softening comonomer selected from the group consisting of methyl acrylate, ethyl acrylate, methyl methacrylate, ethyl methacrylate, and combinations thereof and wherein Y is in the range of 0 to about 50 weight % of the E/X/Y copolymer, and wherein the acid moiety X is neutralized from about 1% to about 90% to form an ionomer with a basic metal salt having a cation such as lithium, sodium, potassium, magnesium, calcium, barium, lead, tin, zinc or aluminum, or a combination; with
ii a multi-functional modifier is selected from the group consisting of, 4-amino-2-hydroxybenzoic acid; 2-amino-5-hydroxybenzoic acid; 3-amino-4-hydroxybenzoic acid; 4-amino-3-hydroxybenzoic acid; 4-amino-3-hydroxybutyric acid; 4-amino-2-hydroxybutyric acid; metal or non-metal salts thereof and combinations thereof; and
c a basic salt comprising;
i a basic metal ion salt is selected from the group consisting of zinc oxide, zinc hydroxide, zinc carbonate, magnesium oxide, magnesium hydroxide, magnesium carbonate, sodium carbonate, potassium carbonate, lihium carbonate and combinations thereof; or
ii a basic non-metal ion salt having the ammonium cation, NH₄⁺.

24. The golf ball of claim 21 wherein said core;
a has a diameter greater than or equal to 1 inch;
b a PGA compression of less than about 140; and
c comprises a peptizer selected from the group consisting of an organic sulfur compound, a metal salt of an organic sulfur compound, a non-metal salt of an organic sulfur compound, and any and all combinations thereof.

25. A polyurethane ionomer comprising the reaction product of
a an isocyanate;
b a multi-functional modified ionomer, wherein the multi-functional modified ionomer is a product of reacting
i an ionomer; and
ii a multi-functional modifier wherein the multi-functional modifier includes at least one carboxyl functional group and at least two additional types of functional groups; and
c a basic salt selected from the group consisting of basic metal ion salts, basic non-metal ion salts and combinations thereof.

26. The polyurethane ionomer of claim 25 wherein;
a said isocyante is selected from the group consisting of aliphatic isocyanates, arylaliphatic isocyanates, alicyclic isocyanates, aromatic isocyanates and combinations thereof
b said multi-functional modified ionomer is a product of reacting
i an ionomer selected from the group consisting of a unimodal ionomer, a bimodal ionomer, a modified unimodal ionomer, a modified bimodal ionomer and any and all combinations thereof; with
ii a multi-functional modifier wherein the at least two additional types of functional groups are selected from the group consisting of hydroxyl, isocyanate, acid anhydride, and amino and any and all mixtures thereof; and
c said basic salt comprises
i a basic metal ion salt having a cation selected from the group consisting of Li⁺, Na²⁺, Zn²⁺, Ca²⁺, Co²⁺, Ni²⁺, Cu²±, Pb²⁺, Mg²⁺ and combinations thereof; or
ii a basic non-metal ion salt having an ammonium cation having the general formula [NR¹R²R³R⁴]⁺ where R¹, R², R³ and R⁴ includes one or more of hydrogen, a C₁-C₂₀ aliphatic, cycloaliphatic or aromatic moiety and any and all combination thereof.

27. The polyurethane ionomer of claim 25 wherein;
a said isocyante is selected from the group consisting of 2,2′-, 2,4′-, and 4,4′-diphenylmethane diisocyanate (MDI); 3,3′-dimethyl-4,4′-biphenylene diisocyanate (TODI); toluene diisocyanate (TDI); para-phenylene diisocyanate (PPDI); meta-phenylene diisocyanate (MPDI); polyphenylene polymethylene polyisocyanate (PMDI) 1,6-hexamethylene diisocyanate (HDI); methylcyclohexylene diisocyanate (HTDI); isophorone diisocyanate (IPDI); meta-tetramethylxylene diisocyanate (m-TMXDI); para-tetramethylxylene diisocyanate (p-TMXDI); and mixtures thereof;
b said multi-functional modified ionomer is a product of reacting
i a unimodal ionomer of general formula, E/X/Y polymer, wherein E is ethylene, X is acrylic or methacrylic acid, and is present in an amount from about 2 to about 35 weight % of the E/X/Y copolymer, and Y is a softening comonomer selected from the group consisting of methyl acrylate, ethyl acrylate, methyl methacrylate, ethyl methacrylate, and combinations thereof and wherein Y is in the range of 0 to about 50 weight % of the E/X/Y copolymer, and wherein the acid moiety X is neutralized from about 1% to about 90% to form an ionomer with a basic metal salt having a cation such as lithium, sodium, potassium, magnesium, calcium, barium, lead, tin, zinc or aluminum, or a combination; with
ii a multi-functional modifier is selected from the group consisting of, 4-amino-2-hydroxybenzoic acid; 2-amino-5-hydroxybenzoic acid; 3-amino-4-hydroxybenzoic acid; 4-amino-3-hydroxybenzoic acid; 4-amino-3-hydroxybutyric acid; 4-amino-2-hydroxybutyric acid; metal or non-metal salts thereof and combinations thereof; and
c said basic salt comprises;
i a basic metal ion salt is selected from the group consisting of zinc oxide, zinc hydroxide, zinc carbonate, magnesium oxide, magnesium hydroxide, magnesium carbonate, sodium carbonate, potassium carbonate, lihium carbonate and combinations thereof; or
ii a basic non-metal ion salt having the ammonium cation, NH₄⁺.

28. A polyurethane ionomer comprising the reaction product of a multi-functional modified ionomer with an isocyanate, wherein the multi-functional modified ionomer is a product of reacting an ionomer with a multi-functional modifier wherein the multi-functional modifier includes at least one carboxyl functional group and at least two additional types of functional groups.
